(19) United States
(12) Patent Application Publication
(10) Pub. No.: US 2018/0235156 A1
(43) Pub. Date: Aug. 23, 2018

(54) High Density Horticulture Growing Systems, Methods and Apparatus

(71) Applicant: E Agri Pte Ltd, Singapore (AU)

(72) Inventors: Nigel Blair, Malvern East Victoria (AU); Simon McMahon, South Melbourne Victoria (AU); Justin Clarke, Brisbane Queensland (AU)

(21) Appl. No.: 15/751,761

(22) PCT Filed: Aug. 11, 2016
(86) PCT No.: PCT/AU2016/050730

§ 371 Date: Feb. 9, 2018

(30) Foreign Application Priority Data
Aug. 11, 2015 (AU) 2015903244

(51) Int. Cl. A01G 9/14; A01G 9/02; A01G 27/00; A01G 9/20; A01G 9/18; A01G 9/24; A01G 9/26

(52) U.S. Cl. CPC A01G 9/143; A01G 9/023; A01G 27/003; A01G 9/20; A01G 31/06; A01G 9/241; A01G 9/1438; A01G 9/247; A01G 9/26; A01G 9/18

(57) ABSTRACT

A high density horticulture growing system comprises a plurality of containers in which crops are grown and one or more elevator devices to automatically move the containers between vertically spaced levels of one or more modular racks. Each elevator device comprises a carrier to transport the containers between the vertically spaced levels and a ram to push the containers from the carrier onto one or more longitudinal supports at the vertically spaced levels. A first conveying device moves containers at least horizontally from a crop planting area to each rack and a second conveying device moves containers at least horizontally from each rack to a crop storage area. One or more processors control movement of the containers, watering of the crops, temperature, lighting and other parameters of the system. A plurality of the high density horticulture growing systems are in communication with a centralised data monitoring and collection system for the transmission and reception of data relating to the growing of crops.

### FIELD OF THE INVENTION

The present invention relates to high density horticulture growing systems, methods and apparatus. In particular, but not exclusively, the present invention relates to crop movement, heating, cooling, watering and control systems, methods and apparatus for high density horticulture growing systems.

### BACKGROUND TO THE INVENTION

High density horticulture growing systems are used in efforts to provide sustainable and efficient food production. These systems often comprise closed loop nutrient solutions built to provide simple and controlled access to nutrients to minimise waste and environmental pollution.

Prior art systems have typically been based on simple rack, pot and pipe systems that are angled towards natural light. One problem with these systems is the unequal distribution of light over the growing crops. The functionality of these systems is limited such that it does not allow for easy rotation of the crop in an effort to equalise the distribution of light.

More complex prior art horticulture systems have costly motorised closed loop conveyors to periodically move the crop depending on the growing stage. However, the conveyors of these systems only allow for the shifting of plants for seeding, germination, separate growth stages and harvesting.

Another problem with prior art horticulture systems is that they are often a fixed size or arrangement and they cannot be built to any height, or scaled for demand. Prior art horticulture systems also typically consume large amounts of energy in lighting and/or movement systems and can produce “weak” crops because the crops are too protected from natural growing conditions.

Another drawback of prior art horticulture systems is that they often require expert and complex onsite installation and maintenance. This can be costly for construction and for ongoing monitoring and labour costs.

Many prior art horticulture systems only offer partial solutions in that they only provide one or some, but not all stages of the process from seeding, growing, harvesting through to packaging ready for sale. Costs and resources are therefore consumed, for example, in transporting harvested crops to a packaging location. Furthermore, the tracking and traceability of crops grown in prior art horticulture systems is either not possible or limited.

### OBJECT OF THE INVENTION

It is a preferred object of the invention to provide an improved high density horticulture growing system and/or method and/or apparatus that addresses or at least ameliorates one or more of the aforementioned problems of the prior art and/or provides a useful commercial alternative.

### SUMMARY OF THE INVENTION

Generally, the present invention relates to high density horticulture growing systems, methods and apparatus. In particular, but not exclusively, the present invention relates to crop movement, heating, cooling, watering and control systems, methods and apparatus for high density horticulture growing systems.

In one form, although not necessarily the broadest form, the invention resides in a high density horticulture growing system comprising:

containers in which crops are grown; and

one or more elevator devices to automatically move the containers between vertically spaced levels.

In preferred embodiments, the high density horticulture growing system comprises one or more racks each comprising a plurality of the vertically spaced levels.

Suitably, each rack comprises one or more supports at each of the vertically spaced levels, each of the supports preferably comprising a low friction surface.

Suitably, each rack comprises a frame to which the supports are coupled.

In some embodiments, each support comprises one or more brackets at each end of the support to couple the support to the frame at a selected height.

Suitably, each rack is modular such that the number of vertically spaced levels can be changed.

Preferably, each of the elevator devices comprises a carrier to transport the containers between the vertically spaced levels.

Suitably, the carrier of each of the elevator devices comprises a platform to support one or more containers and the platform is inclined.

In some embodiments, each of the elevator devices comprises a ram, such as a hydraulic ram or an electric ram, to push the containers from the carrier onto the one or more supports at the vertically spaced levels.

Suitably, the carrier of each of the elevator devices is mounted to one or more vertical guides.

In some embodiments, each of the elevator devices comprises a drive system to move the carriers along the guides between the vertically spaced levels.

Suitably, the drive system comprises a chain drive or a belt drive coupled to the carrier and a motor which drives the chain drive or the belt drive to move the carrier.

Suitably, each of the elevator devices comprises a safety line to support the carrier if the chain drive fails.

In preferred embodiments, the high density horticulture growing system comprises a first elevator device adjacent a first side of each rack and a second elevator device adjacent a second and opposing side of each rack.

Preferably, the high density horticulture growing system comprises a watering system to water the crops in each rack.

Suitably, the watering system comprises a primary watering system to provide water to containers on a highest level of each rack and optionally to one or more lower levels of each rack.

Suitably, the watering system comprises a secondary watering system to circulate water through at least part of the supports of each rack.

Suitably, the watering system comprises one or more water outlets on each rack which align with a respective input aperture in each container to provide water to the container when the container is in a predetermined position on the rack.

In some embodiments, each container is elongate and preferably comprises a plurality of crop apertures to receive crops.

Suitably, each container comprises one or more channels to direct the water to the crops.

Suitably, each container comprises an output aperture to enable at least some of the water to exit the container.

Suitably, a temperature of the water in the primary watering system and/or the secondary watering system is controlled to control a temperature of the containers, the supports and/or the air surrounding the rack.

In some embodiments, the rack comprises artificial lighting, such as one or more light emitting diodes (LEDs), at one or more levels of the rack, such as at every second level of the rack.

Suitably, the rack comprises one or more air blowers, such as one or more fans at one or more levels of the rack.

Suitably, the rack comprises one or more readers to read a unique identifier from each of the containers as the container passes a location on the rack.

In some embodiments, the high density horticulture growing system comprises a first conveying device to move containers to each rack from a crop planting area.

Suitably, the first conveying device includes an inclined section which slopes downward from the crop planting area toward a lower region of the respective rack.

Suitably, the carrier of one of the elevator devices lifts containers, transported to the rack by the first conveying device, to a highest level of the respective rack.

In some embodiments, the high density horticulture growing system comprises a second conveying device to move containers from each rack to a crop storage area.

Suitably, the second conveying device includes one or more driven rollers to move the containers from the rack to the crop storage area.

Suitably, the carrier of one of the elevator devices lowers containers onto the second conveying device from one or more levels of the respective rack.

Suitably, the second conveying device receives containers from the first conveying device, and the carrier of one of the elevator devices lifts the containers from the second conveying device onto the respective rack.

Suitably, when a container is moved from one of the racks to a crop storage area, the respective rack receives a container from the crop planting area.

In some embodiments, the high density horticulture growing system comprises a processor to control one or more aspects of the high density horticulture growing system, such as loading and unloading of the containers, movement of the containers between levels of the rack, movement of the containers between planting, growing, harvesting and storage areas, planting times, growing durations, harvesting times, watering, cleaning, power consumption, and growing conditions including, for example, fertilisers, nutrients, carbon dioxide (CO₂) levels, light spectrum, lighting levels, temperature, humidity, ventilation and air pressure.

Suitably, the high density horticulture growing system comprises one or more sensors to monitor one or more parameters relating to the high density horticulture growing system.

For example, the one or more sensors can include temperature sensors, humidity sensors, light sensors, cameras, location sensors, product traceability sensors, irrigation sensors, water quality sensors, electrical conductivity and pH sensors, carbon dioxide sensors and plant growth sensors.

In another form, although not necessarily the broadest form, the invention resides in a building housing the high density horticulture growing system described above.

Suitably, a positive pressure is maintained within the building.

In some embodiments, a roof of the building, and optionally one or more walls of the building, is/are transparent to enable natural light to enter the building.

For example, the roof and/or the one or more walls are made from glass or a dual layer plastic.

Suitably, the roof comprises one or more openable and closable vents.

Suitably, the building comprises a fan to circulate air.

Suitably, one or more movable shade screens are provided adjacent the roof and/or one or more of the walls.

In yet another form, although not necessarily the broadest form, the invention resides in a crop growing method comprising:

growing crops in containers; and

automatically moving the containers between vertically spaced levels via one or more elevator devices while the crops grow.

Preferably, the method comprises moving the containers between the vertically spaced levels via the one or more elevator devices to control growth conditions for the crops in the containers.

Suitably, the method comprises moving each of the containers through a highest of the vertically spaced levels to expose the crops in the respective container to maximum natural light levels.

Suitably, one or more of the containers receive a similar amount of natural light during a predetermined period. For example, each container comprising a certain crop is moved such that it receives a similar amount of natural light during the predetermined period.

Suitably, the method comprises moving each of the containers to the highest of the vertically spaced levels for the same, or a similar, duration each day during daylight.

In some embodiments, the method comprises watering the crops in the containers when the containers are at the highest of the vertically spaced levels.

Suitably, a rack supports the containers at the vertically spaced levels.

In some embodiments, the method comprises receiving a first container from a first level of the rack on a carrier of a first elevator device.

Suitably, the method comprises pushing the first container from the carrier onto a second level of the rack.

Suitably, one or more second containers on the second level of the rack are pushed along the second level by the first container.

Suitably, at least one of the second containers is pushed from an opposing side of the second level onto a carrier of a second elevator device by the first container.

The method preferably comprises moving containers at least horizontally to each rack from a crop planting area via a first conveying device.

The method preferably comprises moving containers at least horizontally from each rack to a crop storage area via a second conveying device.

In a further form, although not necessarily the broadest form, the invention resides in a non-transitory computer readable medium comprising computer readable code components that when selectively executed by a processor implements one or more aspects of the present invention. For example, the selective execution of the computer readable code components by the processor causes one or more elevator devices to automatically move containers in which plants are growing between vertically spaced levels.

In a further form, although not necessarily the broadest form, the invention resides in a kit for the aforementioned high density horticulture growing system, wherein the kit is transportable in a shipping container.

According to another form, although not necessarily the broadest form, the invention resides in a high density horticulture growing system comprising a crop planting area, a crop growing area and a crop storage area, the system further comprising:

one or more racks each comprising a plurality of the vertically spaced levels;

a first conveying device to move containers, in which crops are grown, at least horizontally to each rack from the crop planting area;

one or more elevator devices to automatically move the containers between the vertically spaced levels of the racks; and

a second conveying device to move containers at least horizontally from each rack to the crop storage area.

The system preferably further comprises a crop harvesting and packing area adjacent the crop storage area.

The system preferably further comprises a computing device in communication with the first and second conveying devices and the one or more elevator devices, the computing device comprising a computer processor in communication with a non-transitory computer readable medium comprising computer readable code components that when selectively executed by the processor cause movement of the containers at least horizontally between the crop planting area, the crop growing area and the crop storage area and movement of the containers between the vertically spaced levels of the racks.

According to another form, although not necessarily the broadest form, the invention resides in plurality of the aforementioned high density horticulture growing systems in communication with a centralised data monitoring and collection system via one or more communication networks, wherein the centralised data monitoring and collection system transmits and receives data relating to the growing of crops to and from the plurality of high density horticulture growing systems.

Further forms and/or features of the present invention will become apparent from the following detailed description.

### BRIEF DESCRIPTION OF THE DRAWINGS

In order that the invention may be readily understood and put into practical effect, reference will now be made to preferred embodiments of the present invention with reference to the accompanying drawings, wherein like reference numbers refer to identical elements. The drawings are provided by way of example only, wherein:

FIG. 1 illustrates a perspective view of a high density horticultural growing system according to one embodiment of the invention;

FIG. 2 illustrates a plan view of the high density horticultural growing system shown in FIG. 1;

FIG. 3 illustrates a side view of the high density horticultural growing system shown in FIG. 1;

FIG. 4 is a front cross-sectional view of part of the high density horticultural growing system shown in FIG. 1 illustrating racks and elevator devices;

FIG. 5 illustrates a perspective view of a container of the growing system according to one embodiment of the invention;

FIG. 6 illustrates a perspective view of a rack and elevator devices of the system according to one embodiment of the invention;

FIG. 7 illustrates a perspective view of a support of the system according to one embodiment of the invention;

FIG. 8 illustrates a perspective view of the elevator device of the system;

FIG. 9 illustrates a perspective view of a motor of the elevator device;

FIG. 10 illustrates part of a drive system of the elevator device;

FIG. 11 illustrates part of a carrier and a ram of the elevator device;

FIG. 12 illustrates movement of a first container to a first level of the rack via a first elevator device;

FIG. 13 illustrates movement of the first container from the first elevator device onto the first level of the rack;

FIG. 14 illustrates movement of a second container from the first level of the rack to a second level of the rack via a second elevator device;

FIG. 15 illustrates movement of the second container from the second elevator device onto the second level of the rack;

FIG. 16 is a perspective view of a lowest support of the rack comprising a second conveying device according to one embodiment of the invention;

FIG. 17 is a perspective view of a bench comprising a storage area according to one embodiment of the invention;

FIG. 18 is a side view of the bench and the lowest level of the rack showing movement of a container via a first conveying device to the second conveying device;

FIG. 19 is a side view of the bench and the lowest level of the rack showing movement of a container from the second conveying device to the storage area;

FIG. 20 is a front cross-sectional view of the bench taken along line 12 shown in FIG. 3;

FIG. 21 is a front view of part of the rack and the elevator device showing a container being loaded/unloaded from the second conveying device by the elevator device;

FIG. 22 is a plan view of footings of the building shown in FIG. 1 according to one embodiment of the invention;

FIG. 23 is a general flow diagram of a crop growing method in accordance with one embodiment of the invention;

FIG. 24 is a schematic of a computing device in accordance with one embodiment of the invention; and

FIG. 25 is a schematic of a control system in accordance with one embodiment of the invention.

Skilled addressees will appreciate that elements in the drawings are illustrated for simplicity and clarity and have not necessarily been drawn to scale. For example, the relative dimensions of some of the elements in the drawings may be distorted to help improve understanding of embodiments of the present invention.

### DETAILED DESCRIPTION OF THE INVENTION

Generally, the present invention relates to high density horticulture growing systems, methods and apparatus. In particular, but not exclusively, the present invention relates to crop movement, heating, cooling and watering systems, methods and apparatus for high density horticulture growing systems.

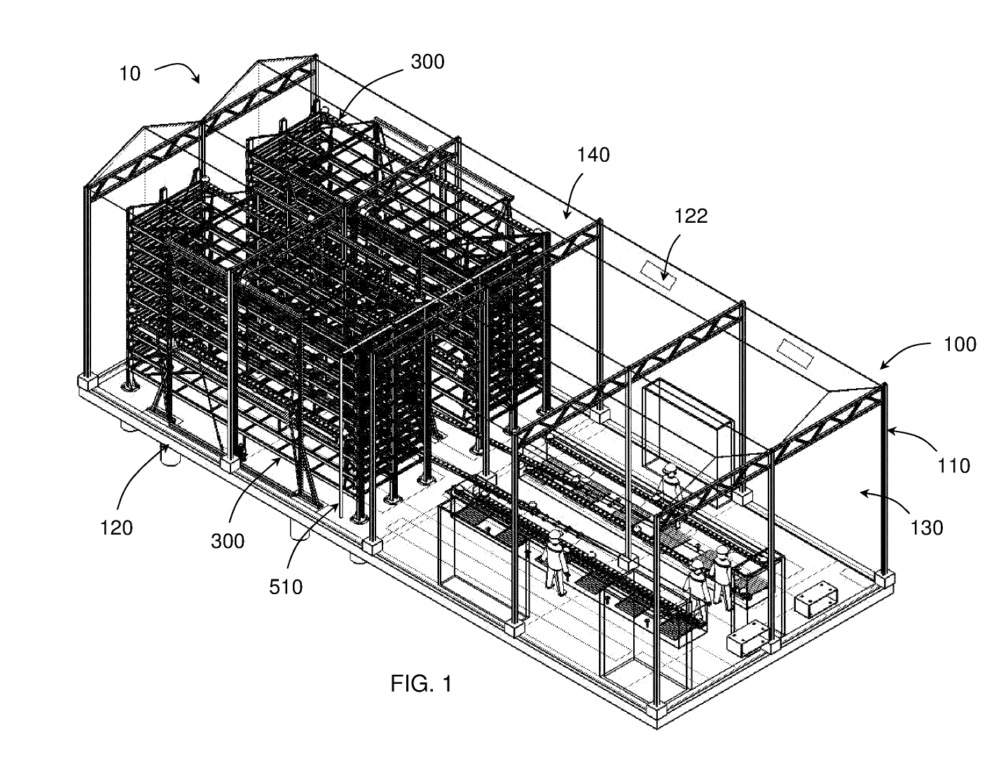

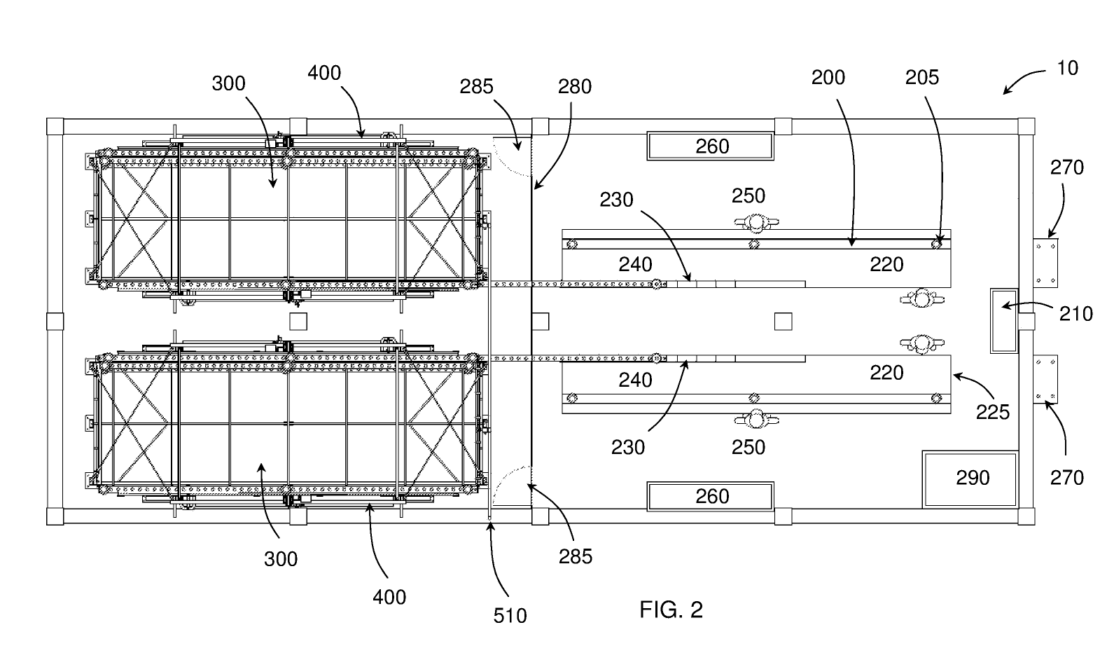

FIG. 1 illustrates a perspective view of a high density horticultural growing system 10 according to one embodiment of the invention. FIGS. 2, 3 and 4 illustrate a plan view, end view and cross-sectional view respectively of the system 10. Generally, the high density horticulture growing system 10 comprises planting areas 220 where crops are planted, racks 300 where crops are grown, and harvesting areas 250 where crops are harvested.

The high density horticulture growing system 10 comprises a building 100 housing the planting areas 220, racks 300 and harvesting areas 250. In preferred embodiments, the building is made from lightweight materials to reduce shipping and installation time and costs. The building 100 comprises frame 110 mounted to foundations 120. Walls 130 and a roof 140 are mounted to the frame 110. The roof 140, or at least part thereof, is transparent to enable natural light to enter the building. One or more of the walls 130, or at least part thereof, can also be transparent to provide additional natural light to the crops. For example, the roof 140 and/or the walls 130 can be made from glass, a dual layer plastic or another suitable transparent material.

In some embodiments, a positive pressure is maintained within the building 100. The positive pressure can provide a controlled environment inside the building 100 and can mitigate the entry of unwanted pollutants into the building 100 that may adversely affect the growth of plants. For example, filtered air enters the building 100 via one or more fans. The roof 140 can comprise one or more openable and closable vents 122, which can, for example, be opened/closed to control the pressure and/or temperature and/or humidity within the building 100. In some embodiments, the positive pressure is set such that air flows out of the vents 122, for example, at 5 m/s.

In some embodiments, the vents 122 are selectively closed to prevent air from flowing into the building through the vents 122. For example, when wind outside the building is above a threshold speed, such as the speed at which air flows out of the vents 122 in still conditions, vents 122 directed toward the wind can be closed, while vents 122 that are not directed toward the wind can be left open. The threshold speed can be determined by the positive pressure within the building 100. In some embodiments, the building 100 comprises a fan to circulate air within the building 100.

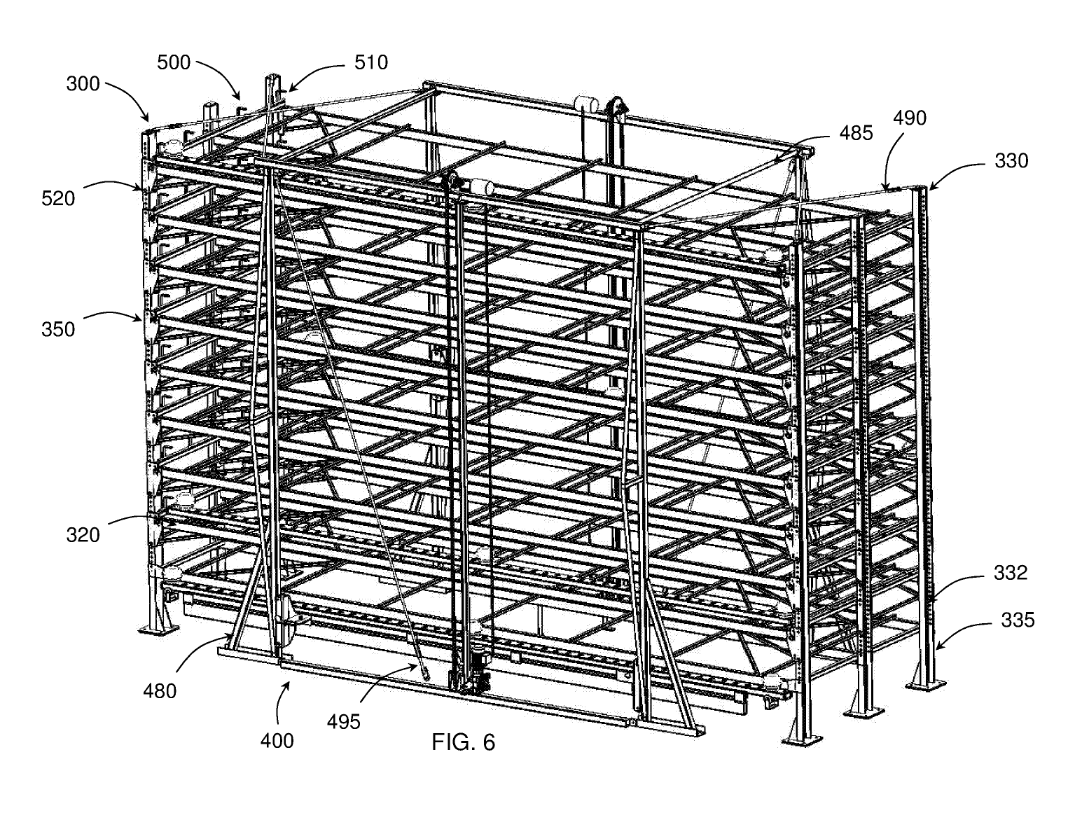

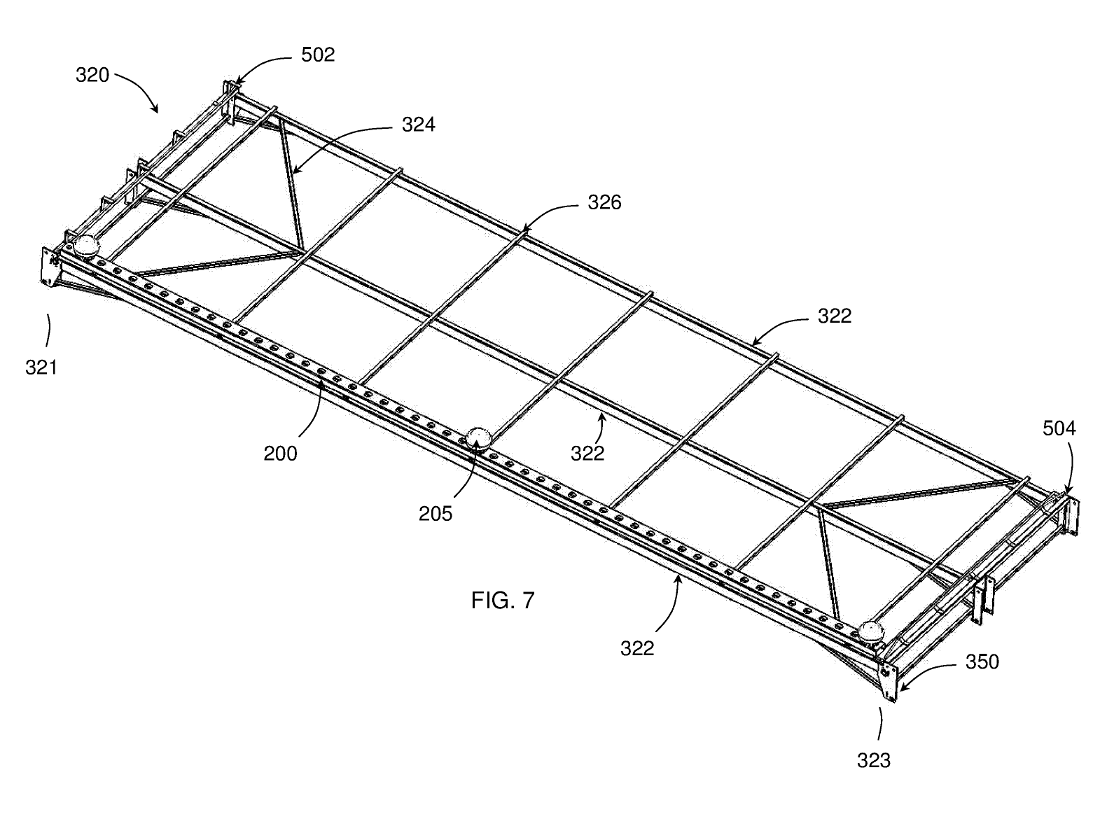

The high density horticulture growing system 10 comprises a watering system 500 (shown, for example, in FIGS. 6 and 7) to water the crops in each rack. The watering system comprises a primary watering system to provide water to one or more containers 200 on the highest level of each rack and optionally to provide water to one or more containers 200 on one or more lower levels each rack, for example, during hot and/or dry weather.

In some embodiments, the high density horticulture growing system 10 comprises solar panels on the roof 140 to power various aspects of the high density horticulture growing system 10 described herein. It will however be appreciated that other power sources can alternatively or additionally be employed.

FIG. 2 illustrates a plan view of the high density horticultural growing system 10. In the growing system 10, seeds are germinated in a germination area 210 at one end of the building. For example, the germination area 210 can comprise one or more racks or cabinets in which the seeds are germinated. The germination area 210 can comprise a thermostat to control the temperature in the germination area 210 to promote growth of crop seedlings and/or small plants.

The crops 205 are removed from the germination area 210 and planted in containers 200 in the planting area 220. FIG. 2 illustrates planting of the crops manually. However, in some embodiments, the crops 205 are automatically moved from the germination area 210 and planted in the containers 200, via a planting system. Once the crops 205 are planted in the containers 200, the containers 200 are moved onto a first conveying device 230 which moves the containers 200 to a respective rack 300 from the crop planting area 220.

Elevator devices 400 are provided on opposing sides of each rack 300. One of the elevator devices of the respective rack 300 lifts containers 200, transported to the rack by the first conveying device 230, onto vertically spaced levels of the respective rack 300. As described in more detail herein, the elevator devices 400 automatically move the containers 200 between vertically spaced levels of the rack 300 while the crops 205 grow. When the crops 205 in a container 200 are ready for harvesting, the container 200 is lowered by one of the elevator devices 400 from a level of the respective rack 300 onto a second conveying device 235. The second conveying device 235 moves the container 200 from the rack 300 to a crop storage area 240.

The crop storage area 240 is dark and stores the crops 205 at cool temperatures, for example, 12 degrees Celsius. The container 200 stays in the crop storage area 240, for a predetermined period, for example, for 24 hours, to allow for the crops 205 in the container 200 to cool. The container 200 is then automatically lifted from the crop storage area 240 to a harvesting area 250, where the crops 205 in the container 200 are harvested. The harvested crop is then packed, for example in cellophane, and placed in a respective adjacent storage area 260. FIG. 2 illustrates manual harvesting of the crops. However, in some embodiments, the crops 205 are automatically harvested from the containers 200, automatically packed and stored in the storage area by a harvesting and packing system. In the embodiment shown in FIG. 2, the harvesting is performed on top of a bench 225 on one side of the bench 225 and the planting is performed on top of the bench 225 on an opposing side of the bench 225.

Once the crops 205 are harvested from a container 200, the container 200 is moved to a cleaner 270 where the container 200 is washed and returned to the planting area 220. For example, the cleaner 270 can be a pressurised cleaner. In some embodiments, the container 200 is moved to the cleaner 270, washed and returned to the planting area 220 automatically via a conveying device. In this embodiment, a cleaner 270 is provided for each respective planting area 220 at the same end of the building 100 as the planting areas 220.

In the embodiment shown in FIG. 2, the building 100 comprises an internal wall or fence 280 dividing the racks 300 from the crop planting area 220 and the crop harvesting area 250. Doors 285 are provided in the internal wall 280 to enable access between the crop planting area 220/the crop harvesting area 250 and the racks 300. In some embodiments, the movement of containers 200 in the rack 300 is stopped when the doors are opened to prevent the possibility of injury. The containers 200 transported by the first conveying device 230 and the second conveying device pass through holes in the internal wall 280. A pressurised entrance 290 is provided to enable access to the building 100. The pressurised entrance 290 can comprise a clean room to mitigate the risk of contaminants entering the building 100.

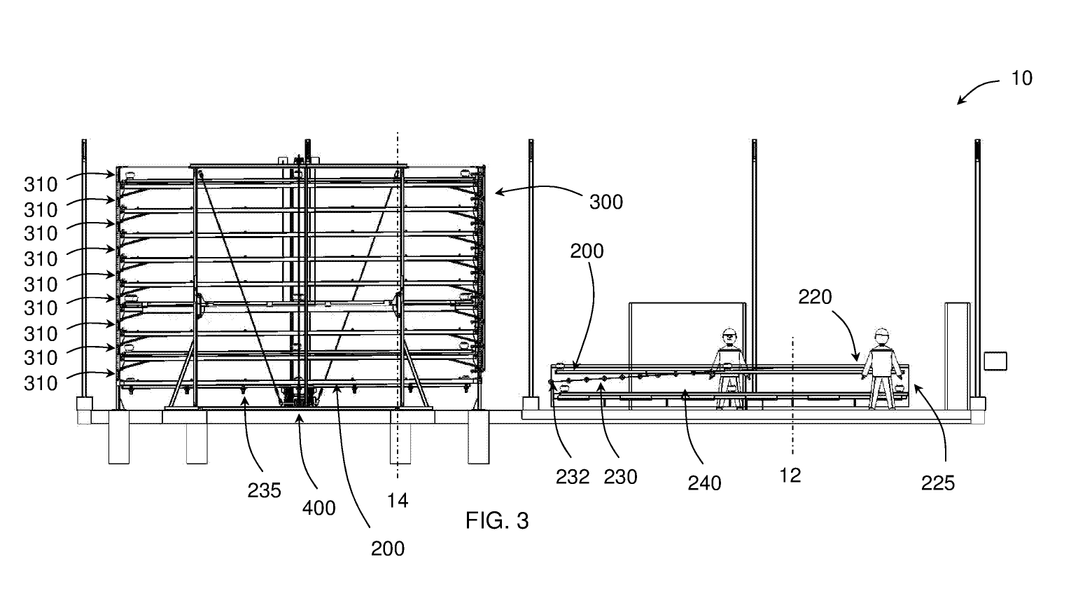

FIG. 3 illustrates a side view of the high density horticultural growing system 10. The first conveying device 230 is inclined downward from the crop planting area 220 to the respective rack 300, and comprises rollers 232 upon which the containers 200 move under the force of gravity. The second conveying device 235 is adjacent the rack 300 and is substantially horizontal (level). The second conveying device 235 receives the containers 200 from the first conveying device 230. Elevator device 400 lifts containers 200 from the second conveying device 235 onto vertically spaced levels 310 of the rack 300. The elevator device 400 can also lower containers 200 onto the second conveying device 235. The second conveying device 235 comprises rollers (not shown) which are driven to move the containers 200 from the second conveying device 235 to the crop storage area 240. The crop storage area 240 is located within the bench 225.

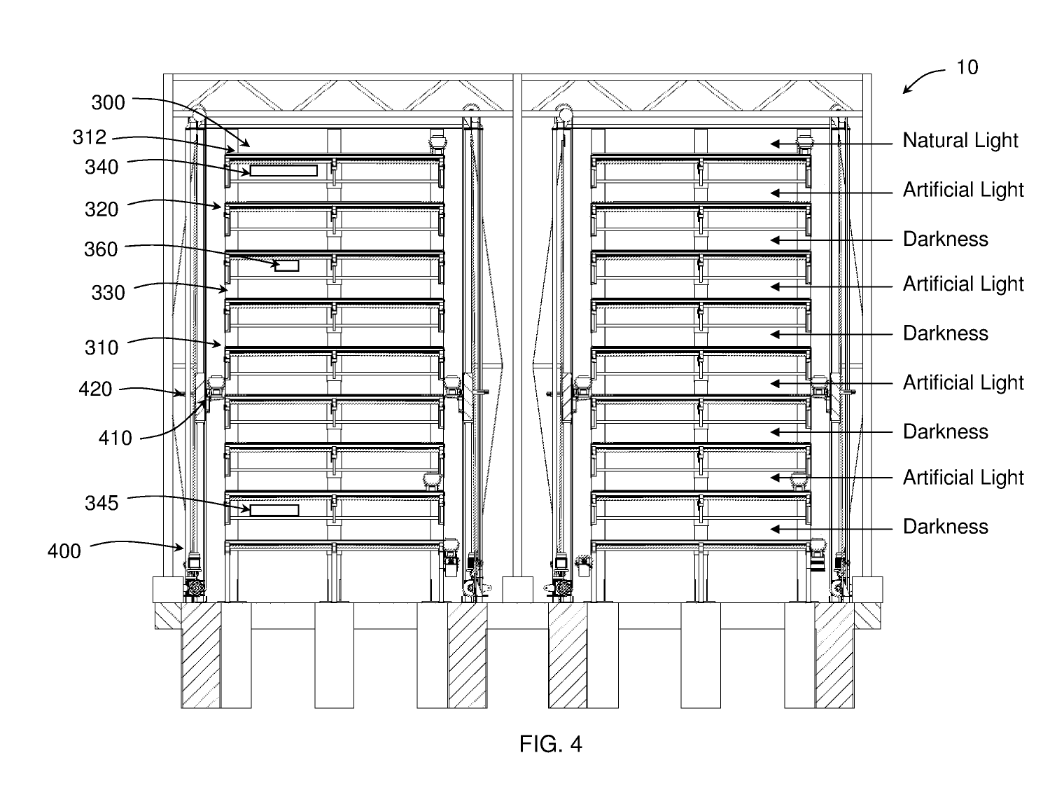

FIG. 4 is a front cross-sectional view of the high density horticultural growing system 10 taken along line 14 shown in FIG. 3, illustrating the racks 300 and the elevator devices 400. Each rack 300 comprises a plurality of vertically spaced levels 310. For example, the racks 300 in FIG. 4 have nine vertically spaced levels 310, but it will be appreciated that the racks 300 can comprise other numbers of levels 310. Each rack comprises a longitudinal support 320 at each of the vertically spaced levels 310. Each rack 300 comprises a frame 330 to which the supports 320 are coupled. In preferred embodiments, each of the supports 320 comprises a low friction surface, for example Ultra-high-molecular-weight polyethylene (UHMWPE), so containers 200 easily slide along the supports 320.

Each of the elevator devices 400 comprises a carrier 410 to transport the containers 200 between the vertically spaced levels 310 and a ram 420 to push a container 200 from the carrier 410 onto the longitudinal supports 320 at the vertically spaced levels 310. The elevator devices 400 automatically move the containers 200 between the vertically spaced levels 310 while the crops 205 grow according to growing protocols as described herein.

In some embodiments, a separate second conveying device 235 is provided on each side of the rack 300, as illustrated in FIG. 4. For example, containers are delivered to the rack 300 from the planting area 220 on one of the second conveying devices 235 and moved from the rack 300 to the storage area 240 on the other of the second conveying devices 235. In some embodiments, the elevator device 400 on a first side of the rack 300 raises/lifts containers 200 and the elevator device 400 on a second and opposing side of the rack 300 lowers containers 200.

Crops 205 in the containers 200 are exposed to natural light at least on a highest level 312 of the rack 300. In the embodiment shown in FIG. 4, artificial lighting 340 is provided on every second level 314 of the rack 300. In FIG. 4, artificial lighting 340 is only shown on one level 312 to avoid cluttering the figure. In other embodiments, artificial lighting 340 can be provided in alternative arrangements, such as on every level 310, on every third level 310 or on every fourth level 310 of the rack 300. The artificial lighting 340 can be, for example, at discrete locations, along the full length of each level, or along part of the length thereof. The artificial lighting 340 can comprise one or more light emitting diodes (LEDs), grow-lights or other suitable types of artificial lighting. A wavelength, or range of wavelengths of the artificial lighting 340, for example, in the red and/or blue spectrum, can be selected based on the type of crops 205 grown on the level 310 and/or based on the growth stage of the crops 205, for example, to promote growth of the crop and/or to increase yield.

In some embodiments, air blowers 345 are provided on one or more levels 310 of the rack 300 to increase airflow over the crops 205. In FIG. 4, an air blower 345 is only shown on one level 310 to avoid cluttering the figure. For example, the air blowers 345 can be fans.

In some embodiments, a reader 360 is provided on one or more levels 310 of the rack 300. In FIG. 4, a reader 360 is only shown on one level 310 to avoid cluttering the figure. The reader 360 reads a unique identifier from each of the containers 200 as the container 200 passes a location on the rack 300 to monitor the location of the containers 200. For example, the unique identifier can be a barcode or a quick response (QR) code or other indicium. The unique identifier can identify the container 200, the crop type, the day on which the crops 205 in the container 200 were planted, and/or a scheduled day/time on which the crops 205 are to be harvested.

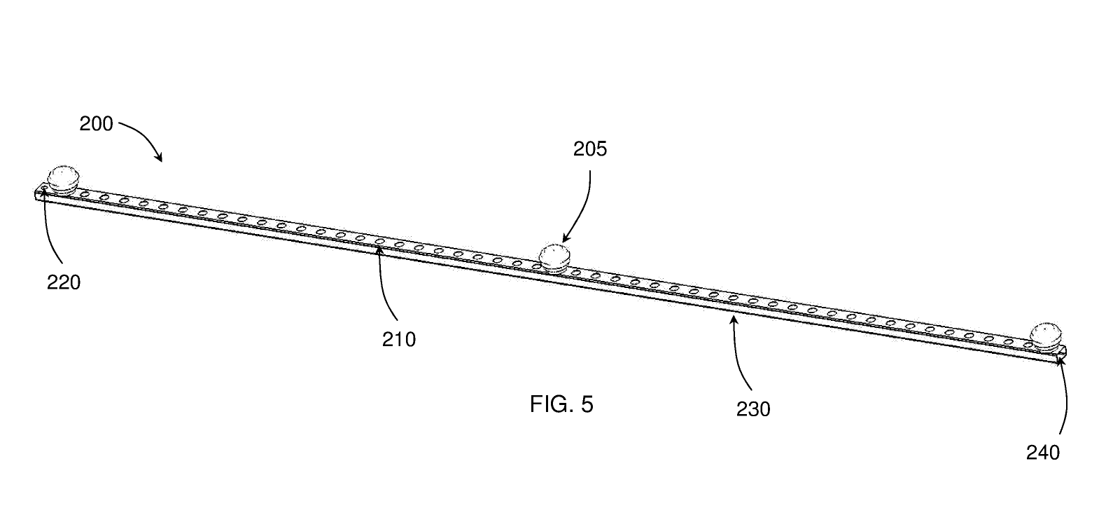

FIG. 5 illustrates a perspective view of a container 200 according to one embodiment of the invention. The container 200 is elongate. For example, the container 200 is 6 m long and is of a width and depth suitable for planting and growing crops 205. It will be appreciated that various length, width and depth combinations will be suitable depending on the crop and space available. The container 200 comprises a plurality of crop apertures 210 to receive crops 205. For example, in some embodiments, the container 200 can have up to 50 crop apertures 210. The container 200 also comprises an input aperture 220 to receive water, one or more channels 230 to direct the water to the crops, and an output aperture 240 to enable at least some of the water not taken up by the crops 205 to exit the container 200. The watering system 500 comprises one or more water outlets on each rack 300 which align with the respective input aperture 220 in each container 200 to provide water to the container 200 when the container 200 is in a predetermined position on the rack 300.

FIG. 6 illustrates a perspective view of a rack 300 and elevator devices 400 on opposite sides thereof according to one embodiment of the invention. The elevator devices 400 each comprise a support frame 480. The support frames 480 of the elevator devices 400 are coupled to one another via transverse frame members 485. The support frames 480 are coupled to the rack 300 via tensioning members 490. A further tensioning member 495 secures each support frame 480 to the foundations or floor (not shown).

A watering system 500 is shown comprising a primary watering system 510 to provide water to one or more containers 200 on the highest level 312 of each rack 300, and optionally to provide water to one or more containers 200 on each other level 310 of each rack 300. It will be appreciated that the water can comprise nutrients, the type and quantity being added according to the crop being grown. The watering system 500 comprises a secondary watering system 520 to circulate water through at least part of the longitudinal supports 320 of each rack 300. In some embodiments, a temperature of the water in the primary watering system 510 and/or the secondary watering system 520 is controlled to control a temperature of the containers 200, the supports 320 and/or the air surrounding the rack 300. For example, warmer water is used during winter to warm the containers and the crops and colder water is used during summer to cool the containers and the crops. In some embodiments, water is provided to the crops 205 by flooding the containers 200 and allowing the crops 205 absorb the water. In other embodiments, water flows steadily through the containers 200 to provide water to the crops 205.

The support 320 at each of the levels 310 of the rack 300 comprises brackets 350 at each end of the support 320 to couple the support 320 to uprights 335 of the frame 330 at a selected height. The uprights 335 comprise holes 332 at set locations along their length to enable the supports 320 to be mounted at different heights. In some embodiments, the holes 332 are at an interval of 50 mm to enable the height of each bracket 250 to be adjusted in 50 mm increments. The height at which the bracket 350 is coupled to the uprights 335 can be selected to set a distance or separation between adjacent vertically spaced levels 310. In some embodiments, the height is the same at each end of the longitudinal support 320 such that the support is horizontal. In some embodiments, the height can be selected to be different at each end of the support 320 to enable selection of an angle of inclination to thus incline the support 320 to promote the flow of water through the containers 200 resting on the support 320 in a desired flow direction. For example, the weight of the containers 200 can cause the support 320 and the containers 200 to bend, for example, 3-15 mm depending on the growth stage of the crops 205. The bend in the containers 200 can cause water to pool, for example, near the centre of the container 200. Inclining the support 320 can improve the flow of water through the containers 200 and prevent such pooling.

FIG. 7 illustrates a perspective view of a longitudinal support 320 according to one embodiment of the invention. The support 320 comprises three longitudinal members 322 which are supported by brace members 324. Transverse members 326 are mounted on the longitudinal members 322 to receive and support the containers 200. Each of the transverse members 326 comprises a low friction surface, for example UHMWPE, so containers 200 easily slide across the supports 320. The support 320 comprises brackets 350 at each end of the support 320 to mount the support to the frame 330 of the rack 300. An angle of inclination of the longitudinal members 322 can be adjusted by mounting the brackets 350 at different heights at each end of the support 320. In some embodiments, the support 320 and/or the frame 330 of the rack 300 are made of steel.

Water outlets 502 are provided at a first end 321 of the support 320 which are configured to align with input aperture 220 of containers 200 when the containers are in position on the support 320. A trough 504 is provided at a second end 323 of the support 320 to receive water flowing out of the output aperture 240 of the containers 200. The water from the trough 504 can be recycled by the watering system 500. In some embodiments, the water from the trough 504 is used to power aspects of the growing system 10.

FIG. 8 illustrates a perspective view of the elevator device 400. The carrier 410 of the elevator device 400 is mounted, via a sliding bracket 416, to one or more vertical guides 430. The sliding bracket 416 comprises one or more rollers 418 that slides up and down along the respective vertical guide 430 on the rollers 418. The elevator device 400 comprises a drive system 440 to move the carrier 410 up and down along the vertical guides 430 to move between the vertically spaced levels 310. In some embodiments, the drive system 440 comprises a chain drive and in other embodiments a belt drive can be used. In the embodiment shown in FIG. 8, the drive system 440 comprises a chain 450 coupled to the carrier 410 and a motor 460 which drives the chain 450 to move the carrier 410. The elevator device 400 comprises a safety line 470 to support the carrier 410 if the chain 450 fails. The safety line 470 can comprise a retractor which automatically extends and retracts as the carrier 410 moves slowly, e.g. below a threshold speed, but prevents movement of the carrier 410 if it moves quickly, e.g. above a threshold speed, for example if the carrier 410 suddenly falls.

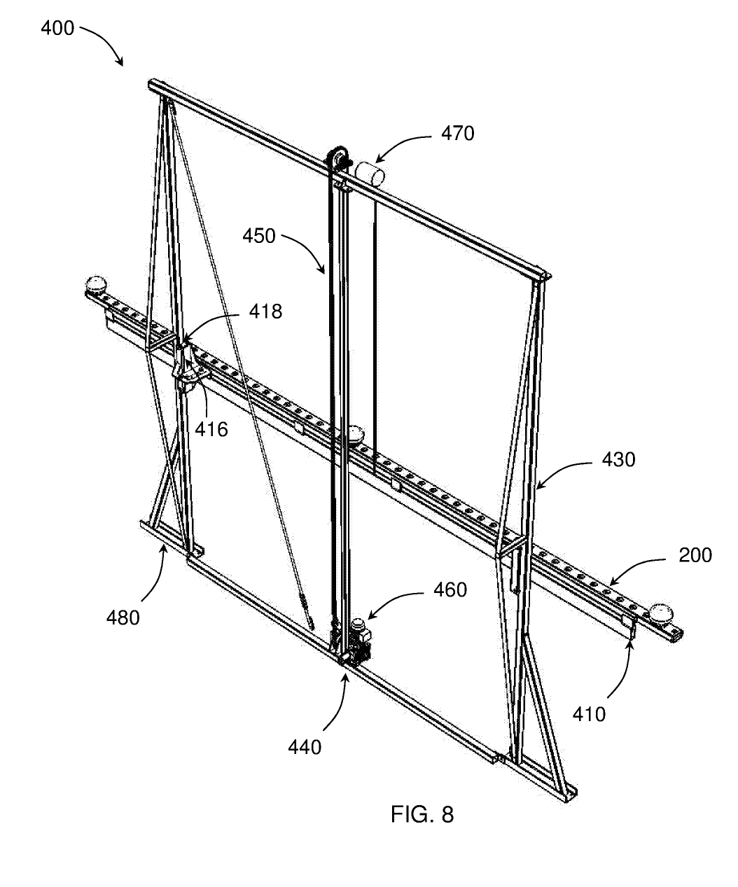

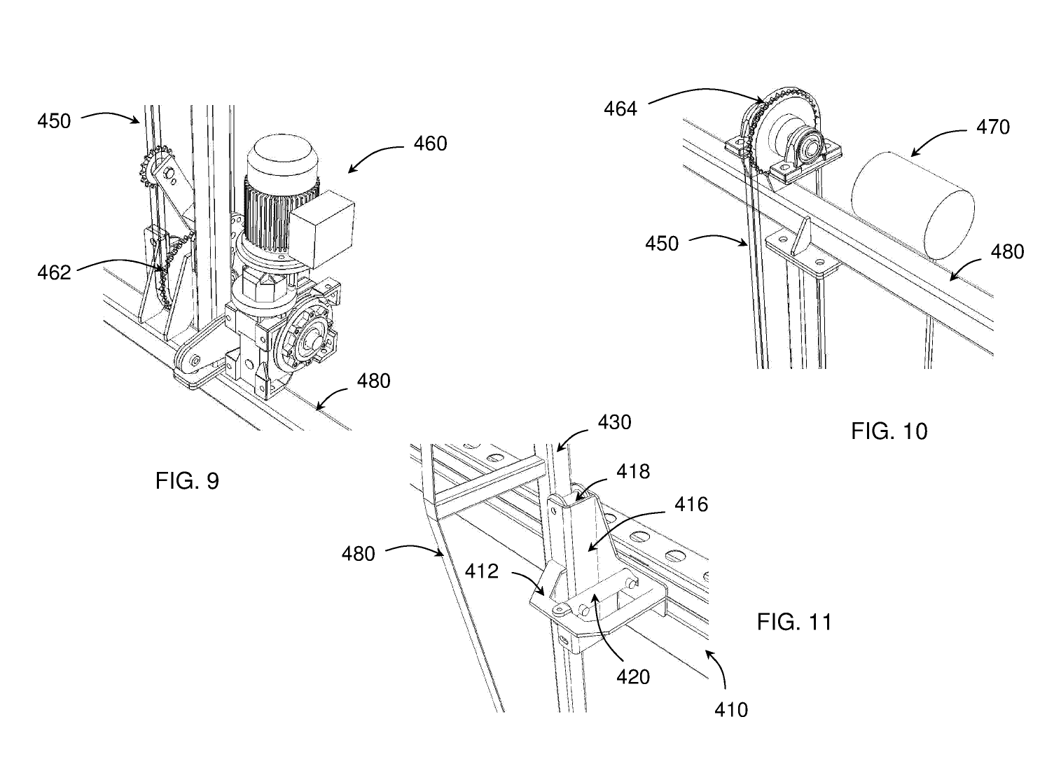

FIG. 9 illustrates the motor 460 in more detail. In preferred embodiments, the containers 200 are moved slowly between the levels 312. For example, in some embodiments, the carrier 410 takes around 3 minutes to move from the lowest level 310 of the rack 300 to the highest level 310 of the rack 300, or vice versa. Therefore, the motor 460 can be, for example, a low power and/or low torque motor, and have, for example, a gearbox to reduce the torque of the motor. The motor 460 drives a sprocket 462 which engages with the chain 450.

FIG. 10 illustrates part of the drive system 440 at an opposing end to the motor 460 in more detail. The drive system 440 comprises a second sprocket 464. The chain 450 passes over the second sprocket 464 and back to the sprocket gear 462. The chain 450 is coupled to the carrier 410 between the sprockets 462, 464.

FIG. 11 illustrates part of the carrier 410 and the ram 420 in more detail. The carrier 410 is movably mounted to the vertical guide 430 via the sliding bracket 416 and moves up and down along the vertical guide 430 smoothly on the rollers 418. The ram 420 is mounted to the carrier 410 via a frame 412. The ram 420 can be a hydraulic ram, a pneumatic ram or an electric ram.

FIGS. 12-15 illustrate examples of the movement of containers 200 between vertically spaced levels 310 according to one embodiment of the invention. A first elevator device 402 is provided adjacent a first side of each rack 300 and a second elevator device 404 is provided adjacent a second and opposing side of each rack 300. Each level 310 of the rack 300 is filled with containers 200. In the example illustrated, each level 310 of the rack 300 comprises 19 containers 200.

As shown in FIG. 12, carrier 410 of the first elevator device 402 transports a first container 202 to a first level 312 of the rack 300, for example, a highest level, on a platform 414 of the carrier 410 of the elevator device 402. The carrier 420 of the second elevator device 404 on the opposite side of the rack 300 moves to be aligned at, or just below, the first level 312.

As shown in FIG. 13, the ram 420 of the first elevator device 402 then pushes the first container 202 onto the first level 312 of the rack 300. Containers 200 on the first level 312 of the rack 300 are pushed along the first level 312 (from right to left in FIG. 13) by the movement of the first container 202 onto the first level 312 such that a second container 204, at an opposing side of the first level 312, is pushed from the opposing side of the first level 312 onto the platform 414 of the carrier 420 of the second elevator device 404.

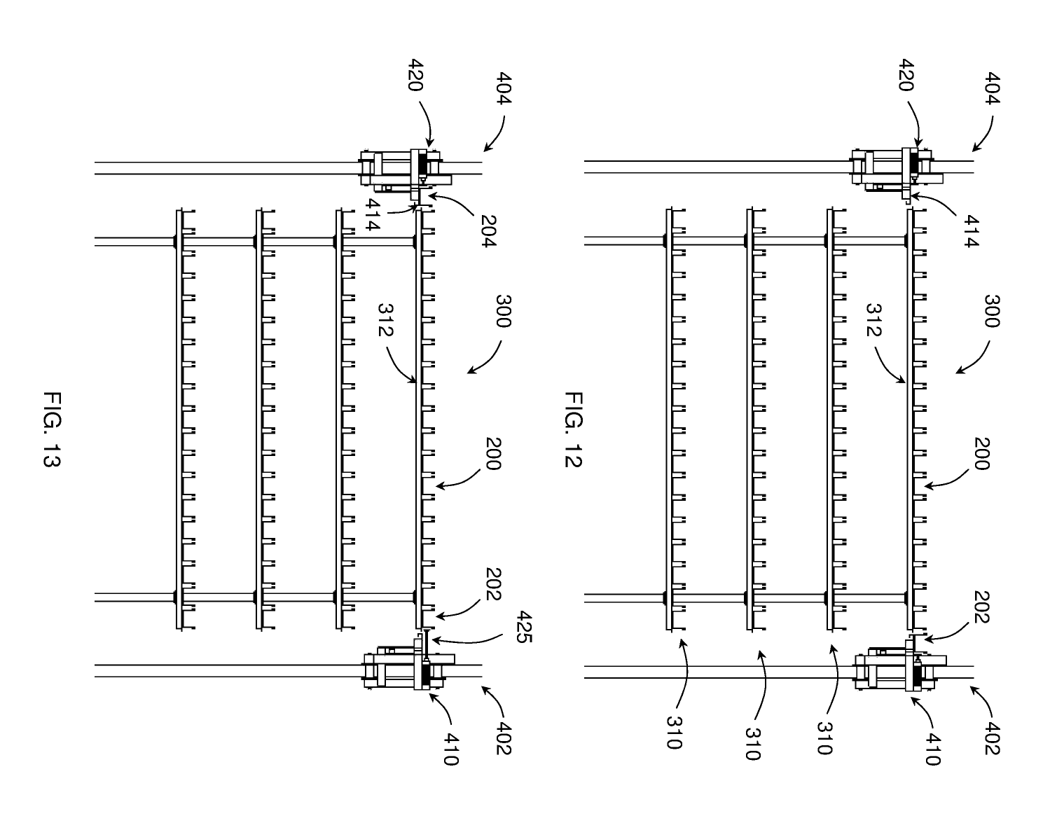

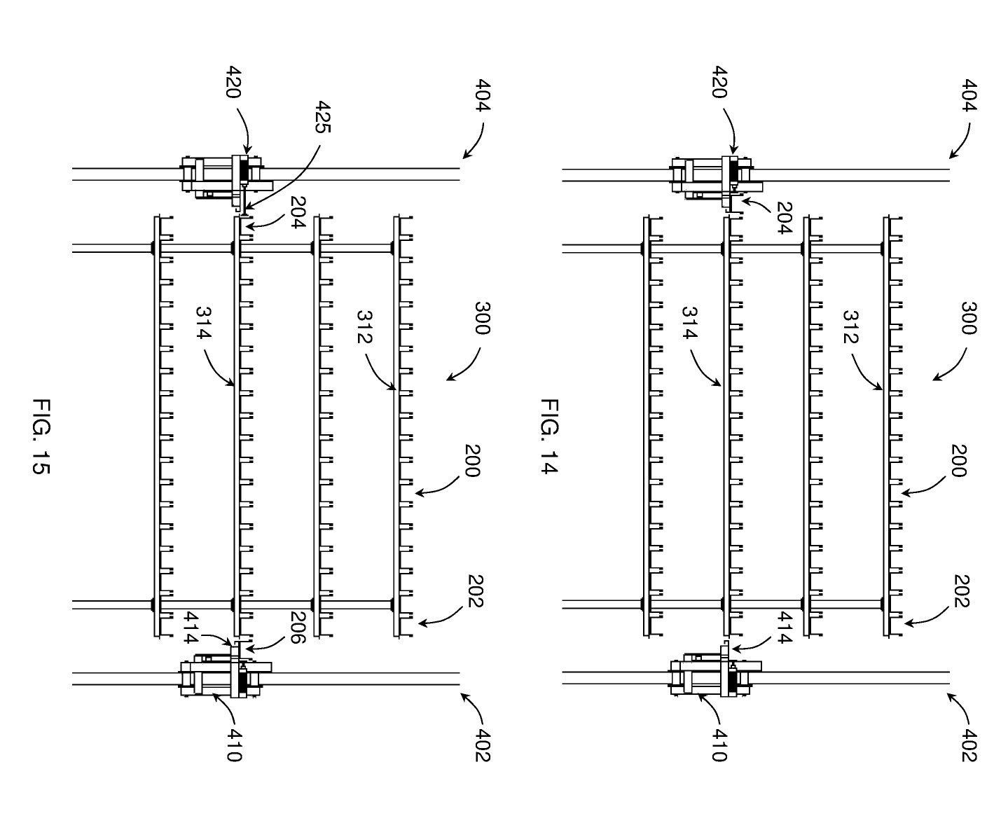

As shown in FIG. 14, the second container 204 is then transported by the carrier 420 of second elevator device 404 to a second level 314 of the rack 300 at a lower level. The carrier 410 of the first elevator device 402 moves to be aligned at, or just below, the second level 314.

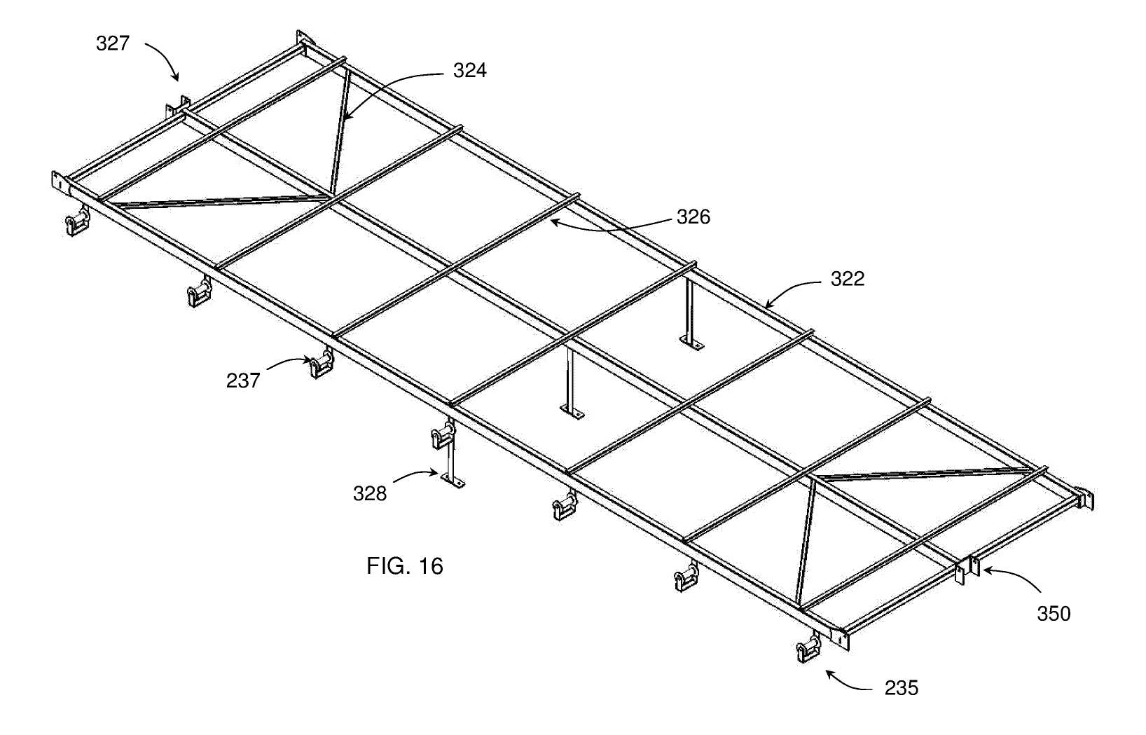

As shown in FIG. 15, the ram 425 of the carrier 420 of second elevator device 404 then pushes the second container 204 onto the second level 314 of the rack 300. Containers 200 on the second level 314 of the rack 300 are pushed along the second level 314 (from left to right in FIG. 15) by the second container 204 such that a third container 206, at an opposing side of the second level 314, is pushed from the opposing side of the second level 314 onto the platform 414 of the carrier 410 of the first elevator device 402. The first elevator device 402 can then transport the third container 206 to another level 310, such as, the first level 312.

In such a way, a container 200 is added to a level and pushed transversely across the level 310 as other containers 200 are added to the level 310. When the container reaches the other side of the level 310, the arrival of a container on the same level at the opposite side pushes the container onto the adjacent carrier of the other elevator device 400 ready for movement to another level 310.

In preferred embodiments, the container 200 is moved to the highest level 312 of the rack 300 first. When the container 200 reaches the other side of the highest level 310, the container is moved to another, lower level 310, such as a second highest level, of the rack 300. The container 200 moves across the other level 310 and then is moved back to the highest level 310. The container 200 moves across the highest level 312 again and is then moved to another, lower level 310, such as a third highest level, of the rack 300. Further details and examples of movement cycles for the containers 200 are provided later in this document.

FIG. 16 is a perspective view of the lowest longitudinal support 327 comprising a second conveying device 235 according to one embodiment of the invention. The lowest support 327 comprises three spaced apart longitudinal members 322, angled brace members 324 and brackets 350. The lowest support 327 is supported by legs 328. Transverse members 326 are mounted on the longitudinal members 322.

The conveying device 235 is coupled to one side of the lowest support 327. The second conveying device 235 is located below the transverse members 326 of the lowest support 327. This enables containers 200 to be transported to, and pushed onto, the lowest support 327 by the elevator device 400, without being obstructed by the second conveying device 235.

The elevator device 400 can move below the lowest support 327 to deposit a container 200 onto the second conveying device 235 and/or to lift a container from the second conveying device 235. The second conveying device 235 comprises rollers 237. The rollers 237 can be driven, for example by a motor, to transport a container 200 along the second conveying device 235, for example, when receiving a container 200 from the first conveying device 230 or moving a container 200 from the rack 300 to the storage area 240.

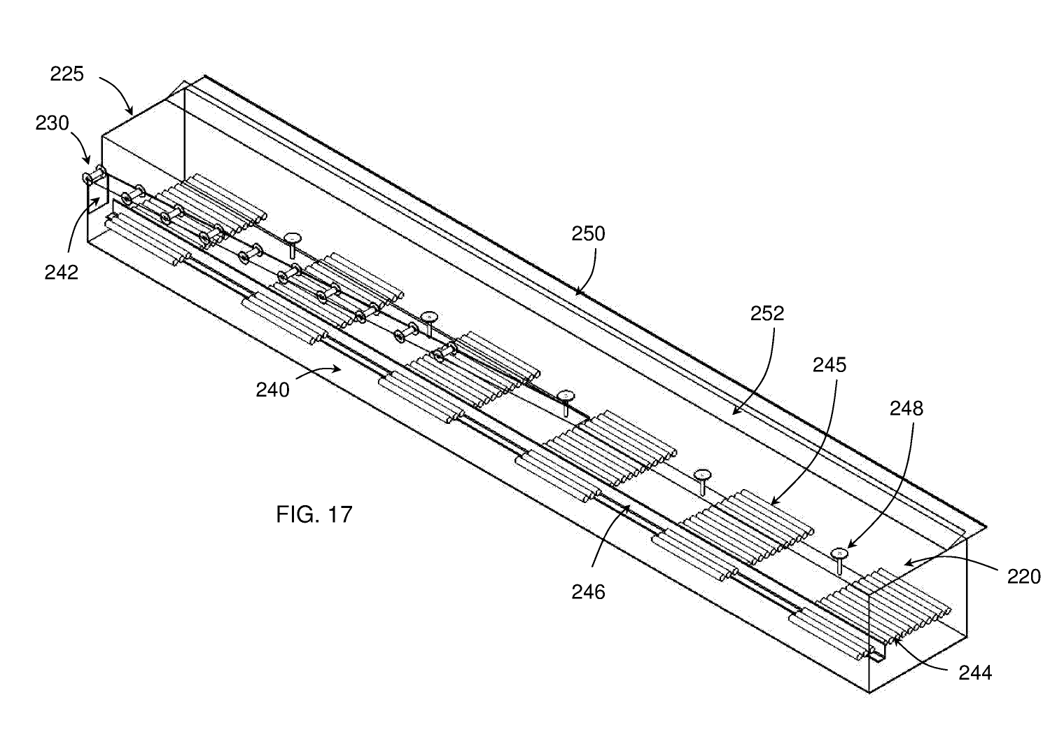

FIG. 17 is a perspective view of the bench 225 comprising the storage area 240 according to one embodiment of the invention. The bench 225 comprises a planting area 220 on a first side on top of the bench 225 and a harvesting area 250 on an opposing side on top of the bench 225. The first conveying device 230 is inclined downward along the first side of the bench 225 from the planting area 220 toward a lower region of the racks 300.

The crop storage area 240 is provided within the bench 225. The crop storage area 240 comprises sealable door 242 at the end of the bench 225 nearest the rack 300. Containers 200 are received from the second conveying device 235 through the sealable door 242 onto rollers 244 in the storage area 240 on the first side of the bench 225. The rollers 244 form an inclined conveyor 245 which transports the containers 200 under gravity to the opposing side of the bench 225. A movable stop 246 is provided on the conveyor 245 to prevent the containers 200 from moving along the conveyor while the container is entering the storage area 240. The stop 246 can be controlled, for example, by a linear actuator, to move the stop 246 downwards and out of the way of the container 200 once the container is detected to be completely inside the storage area 240.

One or more elevators 248 are provided at the opposing side of the storage area 240 to lift containers 200 from the storage area 240 through a sealable door 252 at the top of the bench 225 to the harvesting area 250. Elevators 248 can be any suitable hydraulic, pneumatic or electric elevator.

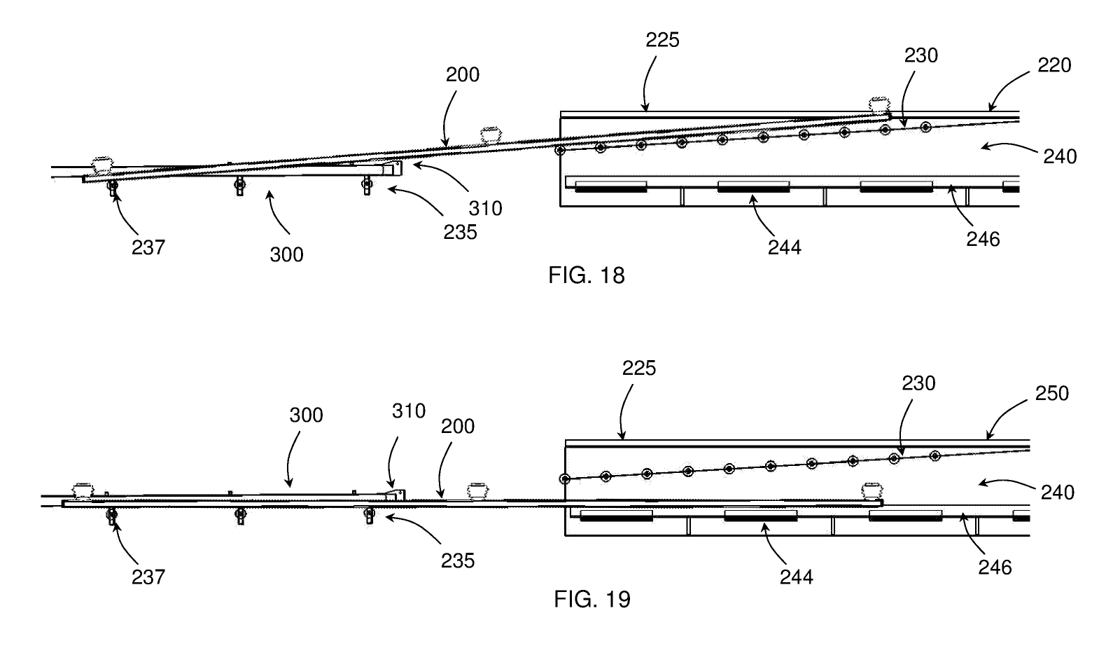

FIG. 18 is a side view of the bench 225 and the lowest level 310 of the rack 300 showing movement of a container 200 from the first conveying device 230 to the second conveying device 235. The container 200 moves down the first conveying device 230 under the force of gravity and onto one or more rollers 237 of the second conveying device 235. In some embodiments, the rollers 237 of the second conveying device 335 are driven to move the container 200 the rest of the way onto the second conveying device 235, for example, so the container 200 can be lifted by the elevator device 400.

FIG. 19 is a side view of the bench 225 and the lowest level 310 of the rack 300 showing movement of a container 200 from the second conveying device 235 to the storage area 240. When the elevator device 400 lowers the container onto the second conveying device 235, the rollers 237 of the second conveying device 235 are driven to move the container 200 into the storage area 240 through the sealable door 242. The rollers 237 can be driven such that the container 200 has enough momentum once it leaves the rollers 237 to move completely inside the storage area 240.

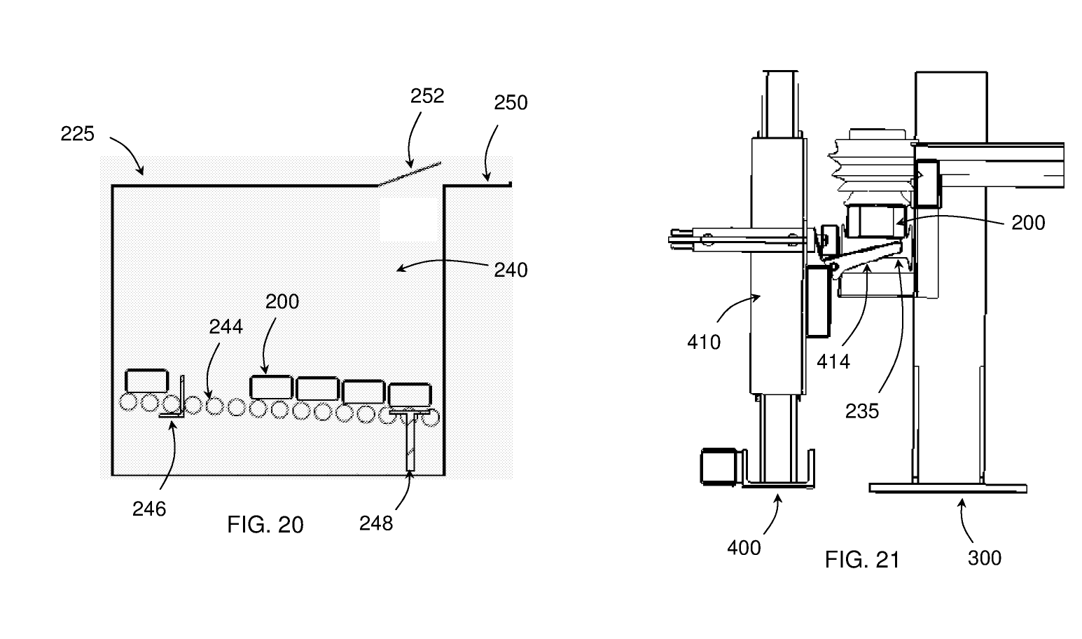

FIG. 20 is a front cross-sectional view of the bench 225 along line 12 shown in FIG. 3, illustrating the crop storage area 240. Containers 200 stay in the storage area 240 for a predetermined duration, such as 24 hours, before being raised/lifted out of the storage area 240 through opened door 252 by elevators 248 to the harvesting area 250. When a container 200 is lifted out of the storage area 240, the other containers 200 in the storage area 240 move along the inclined conveyor 245 formed by the rollers 244 so that another container 200 is in position to be lifted by the elevators 248.

FIG. 21 is a front view of part of the rack 300 and the elevator device 400, showing a container 200 being loaded/unloaded from the second conveying device 235. The platform 414 of the carrier 410 of the elevator device 400 is inclined to receive the container 200 on the carrier 410. This mitigates the risk of the container 200 being received toward the edge of the carrier 410 and falling off the carrier 410.

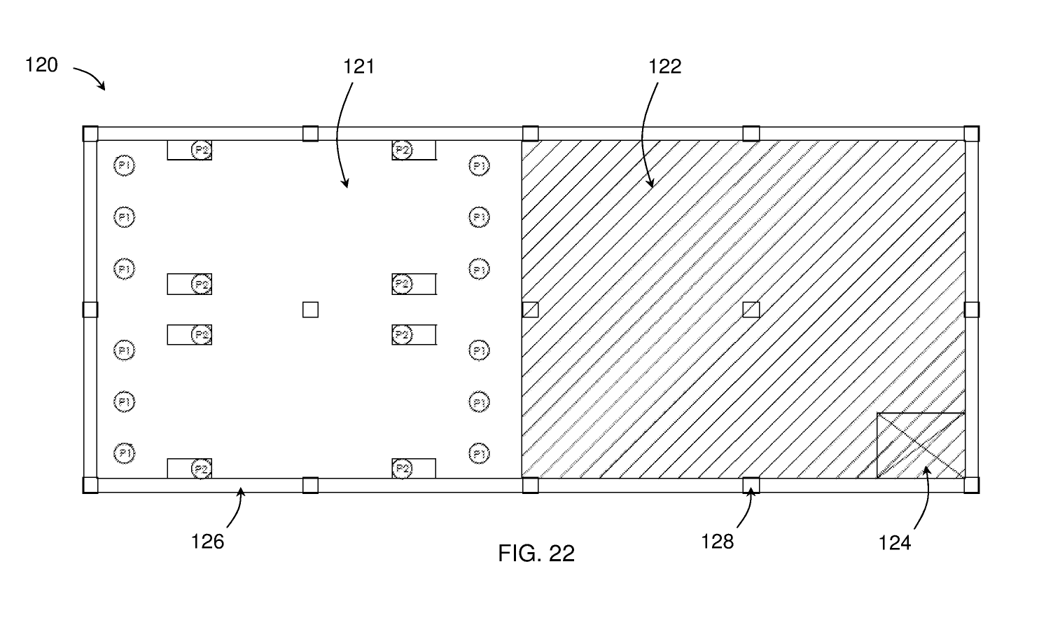

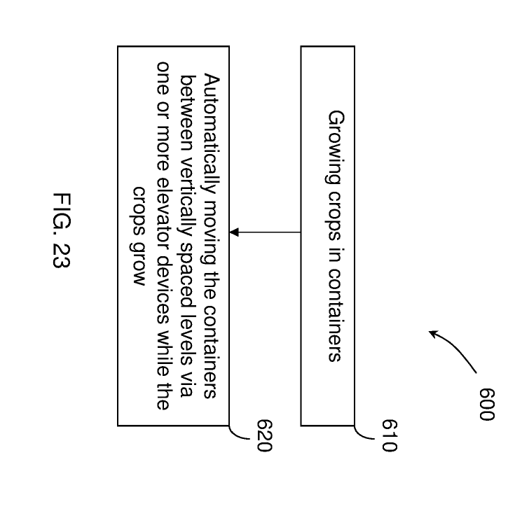

FIG. 22 is a plan view of the footings 120 according to one embodiment of the invention. The footings 120 include piers P1 to which the frames 330 of the racks 300 are mounted, and piers P2 to which the frames 480 of the elevator device 400 are mounted. In a growing area where the racks 300 and elevator devices 400 are located, the ground is covered with weed matting 121. A concrete slab 122 is provided as a floor for the planting and harvesting areas 220, 250. In alternative embodiments, the floor for the planting and harvesting areas can comprise, for example, gravelled ground, plastic covered ground or another weed-preventative barrier. The footings 120 also include column mounts 128 to which the frame 110 is mounted and beams 126 to which the walls 130 are connected. A drain 124 is provided in the floor of the pressurised entrance 290.

FIG. 23 is a general flow diagram of a crop growing method 600 in accordance with one embodiment of the invention. For example, the method can be implemented in the high density horticulture growing system 10 described herein. At step 610, the method 600 comprises growing crops in the containers 200.

At step 620, the method 600 comprises automatically moving the containers 200 between vertically spaced levels 310 via one or more elevator devices 400 while the crops grow. For example, the containers can be moved between the vertically spaced levels 410 via the one or more elevator devices 400 to control growth conditions for the crops in the containers 200, such as lighting, as described herein. In preferred embodiments, the method 600 comprises moving each of the containers 200 through a highest of the vertically spaced levels 312 to expose the crops in the respective container to maximum natural light levels. Each of the containers 200 can be moved to the highest of the vertically spaced levels 312, for example, for the same, or a similar, duration each day during daylight. In some embodiments, the crops in the containers 200 are watered when the containers are at the highest of the vertically spaced levels 312. It will be appreciated that the crop growing method 600 can include further method steps corresponding to the actions involved in growing crops as described herein.

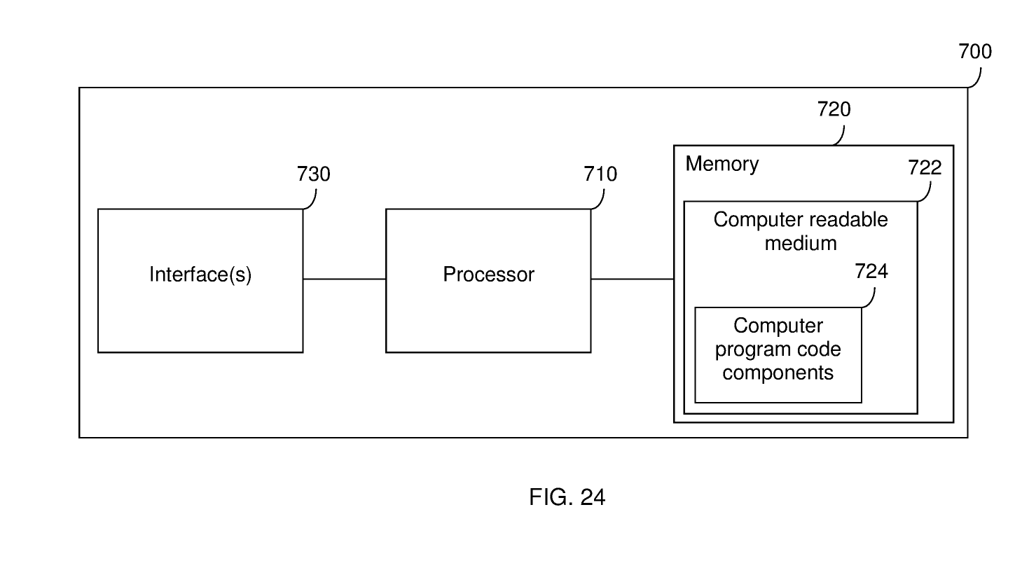

FIG. 24 is a schematic of a computing device 700 in accordance with one embodiment of the invention. The computing device comprises a processor 710 to control one or more aspects of the high density horticulture growing system, such as loading and unloading of the containers 200, movement of the containers between levels 310 of the rack 300 and between the planting, growing, harvesting and storage areas, planting times, growing durations, harvesting times, watering times, durations and volumes, cleaning, power consumption, and growing conditions for the particular crop including, for example, amounts and types of fertilisers and/or nutrients, carbon dioxide (CO₂) levels, light spectrum, lighting levels including timing, duration and intensity, temperature, humidity and ventilation. A memory 720 is coupled to the processor 710. The memory 720 comprises a computer readable medium 722 comprising computer program code components 724 for implementing various aspects of the present invention including various methods and functions of the embodiments described herein. The processor 710 selectively executes the computer program code components 724 stored in the memory 720 to perform the methods 600 and functions of the high density horticulture growing system described herein.

The computer readable medium 722 can also store data such as data received from sensors in the high density horticulture growing system. As will be understood by a person skilled in the art, a single memory, such as the memory 720, can be used to store both dynamic and static data. The structure of the memory 720 is well known to those skilled in the art and can include a basic input/output system (BIOS) stored in a read only memory (ROM) and one or more program modules such as operating systems, application programs and program data stored in random access memory (RAM).

One or more interfaces 730 are coupled to the processor 710 to enable control of the systems described herein and/or programming of the systems described herein. For example, the one or more interfaces 730 can include one or more communications devices and/or one or more user interface elements, such as a display, a touchscreen, a keypad, and/or a keyboard. In some embodiments, the high density horticulture growing system comprises one or more sensors 810 to monitor one or more parameters relating to the high density horticulture growing system and the one or more interfaces 730 receive data from the one or more sensors 810. For example, the one or more sensors can include temperature sensors, humidity sensors, pressure sensors, light sensors, location sensors, such as code readers, cameras, product traceability sensors, irrigation sensors, water quality sensors, electrical conductivity sensors, pH sensors, carbon dioxide sensors and plant growth sensors.

In some embodiments, the memory 720 comprises computer program code components 724 for performing one or more of the steps of the method 600.

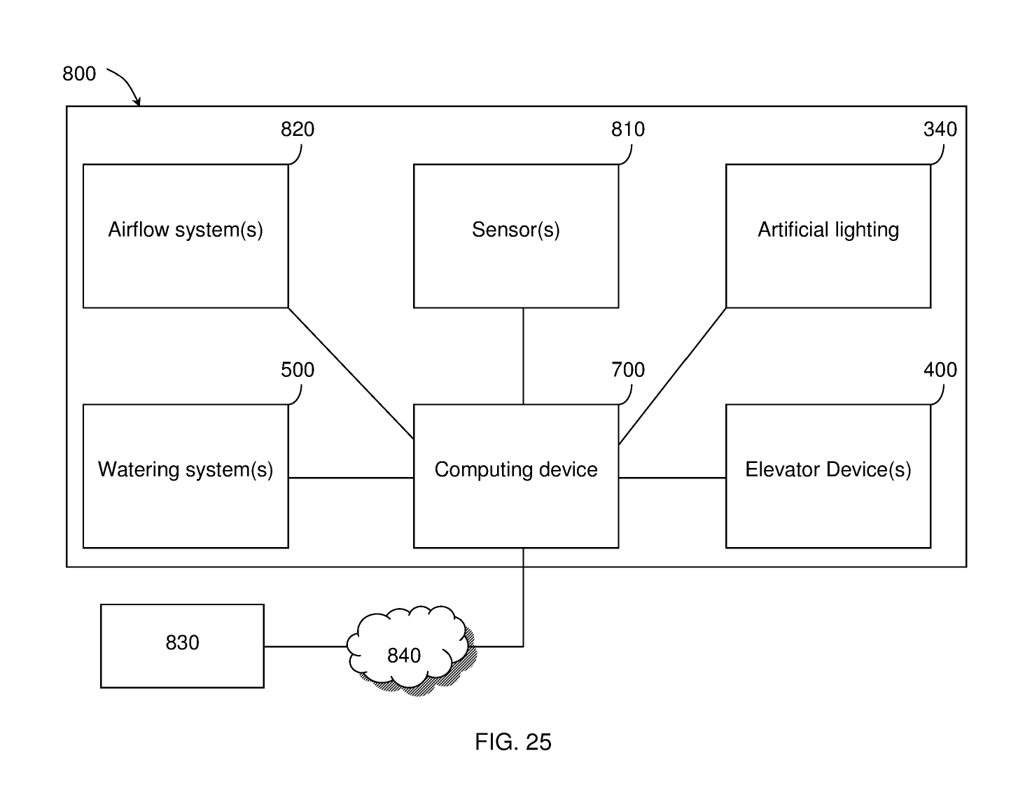

FIG. 25 is a schematic of a control system 800 in accordance with one embodiment of the invention. The control system comprises the computing device 700. The computing device 700 receives data from one or more sensors 810 and controls aspects of the invention discussed herein.

For example, the control system 800 can control the elevator devices 400 to control the movement of the containers 200. In one example, a container 200 is moved in a predetermined sequence through the rack 300 by the elevator devices 400 and then unloaded to the storage area 240. In another example, a location of a container 200 is monitored via the reader(s) 360 or by logging the movements of the containers 200 by the elevator devices 400, and the computing device 700 controls the elevator device(s) 400 to move the container 200 off the rack 300 when the crops 205 in the container 200 are ready for harvesting. In some embodiments, the growth stage of the crops 205 in the containers 200 can be monitored on the computing device 700 via cameras on the racks 300. The computing device 700 can also display a visualisation of the locations of the containers 200 in the racks 300 showing each container's location and the growth stage and/or type of the crops 205 in each container 200. For example, the growth stages and/or types of crops can be colour coded. In some embodiments, the growth stage is automatically determined via the time the containers 200 have been in the racks 300 and/or via the camera images of the crops 205 in the containers 200.

In some embodiments, for example when a crop 205 is identified as having a disease, the computing device 700 implements an emergency unload cycle in which the crop 205 is moved to one side of a level 310 and then unloaded from the rack 300 via the respective elevator 400.

The computing device 700 can also monitor environmental conditions in the building 100, such as temperature, light levels, humidity and air pressure via the one or more sensors 810. The computing device 700 can control the airflow systems, such as the fans and the openable and closable vents 122; the artificial lighting 340; and/or the watering system 500 based on the environmental conditions. In some embodiments, the computing device 700 also controls one or more shade screens provided adjacent the roof 120 and/or one or more of the walls 110 which alter the light entering the building 100 through the roof 120 and/or walls 110.

In some embodiments, the computing device 700 is programmed to operate on a per crop basis. For example, independent and/or predetermined growing cycles can be implemented for each crop 205 or container 200, and/or each individual crop 205 and/or container 200 can be monitored and moved through the system as required.

In some embodiments, the control system 800 stores data remotely, for example, in a cloud based system or a central server. For example, in some embodiments, a centralised data monitoring and collection system 830 can be provided for collection and monitoring of data from each of a plurality of buildings 100 or high density horticulture growing systems via a communications network 840. For example, at each location in which the system is provided, data for existing and new plant varieties can be downloaded from the centralised data monitoring and collection system 830 to the computing device 700 for the growing of the plant varieties at that location. Data relating to the growing of particular plant varieties can be uploaded from each location to the centralised data monitoring and collection system 830 for collation and analysis and for use by other systems at other locations globally.

The skilled addressee will appreciate that the aforementioned examples of monitoring and controlling the planting, growing, storage and movement of crops in the containers 200 can be selectively combined and varied as necessary to optimise the growing conditions for the particular crop being grown and to minimise the consumption of resources.

### Crop Movement Sequences

Example sequences for moving the crops between the vertically spaced levels 310 are provided below. In some sequences, crops 205 receive 1 hour of natural light, 9 hours of artificial light and 8 hours of darkness during an 18 hour period. For example, an 18 hour period is chosen so that crops 205 receive natural light at different times each successive day. An example of such a sequence for a single container 200 in the rack 300 is shown in Tables 1 and 2 below, where Table 1 shows the times at which the container 200 is on the highest level 312 and Table 2 shows the times that the container is at each of the other levels 310.

TABLE 1

| | Start time on | 24 hour | Finish time on | 24 hour | | | |
|---|---|---|---|---|---|---|---|
| | rack (hrs) | time | rack (hrs) | time | | | |
| Cycle 1 | 0 | 0 | 1 | 1 | Day 1 | dark | Movement Left to Right |
| Cycle 2 | 9 | 9 | 10 | 10 | Day 1 | Morning light | Movement Left to Right |
| Cycle 3 | 18 | 18 | 19 | 19 | Day 1 | Dark | Movement Left to Right |
| Cycle 4 | 27 | 3 | 28 | 4 | Day 2 | Dark | Movement Left to Right |
| Cycle 5 | 36 | 12 | 37 | 13 | Day 2 | Afternoon light | Movement Left to Right |
| Cycle 6 | 45 | 21 | 46 | 22 | Day 2 | Dark | Movement Left to Right |
| Cycle 7 | 54 | 6 | 55 | 7 | Day 3 | Dark | Movement Left to Right |
| Cycle 8 | 63 | 15 | 64 | 16 | Day 3 | Afternoon light | Movement Left to Right |
| Cycle 9 | 72 | 0 | 73 | 1 | Day 3 | Dark | Movement Left to Right |

TABLE 2

| | | Finish time on | 24 hour | Start time on | 24 hour | | | |
|---|---|---|---|---|---|---|---|---|
| Level | | rack (hrs) | time | rack (hrs) | time | | | |
| 2 | LED | 9 | 9 | 1 | 1 | Day 1 | LED | Movement Right to Left |
| 3 | Dark | 18 | 18 | 10 | 10 | Day 1 | Dark | Movement Right to Left |
| 4 | LED | 27 | 27 | 19 | 19 | Day 1 | LED | Movement Right to Left |
| 5 | Dark | 36 | 12 | 28 | 4 | Day 2 | Dark | Movement Right to Left |
| 6 | LED | 45 | 21 | 37 | 13 | Day 2 | LED | Movement Right to Left |
| 7 | Dark | 54 | 30 | 46 | 22 | Day 2 | Dark | Movement Right to Left |
| 8 | LED | 63 | 15 | 55 | 7 | Day 3 | LED | Movement Right to Left |
| 9 | Dark | 72 | 0 | 64 | 16 | Day 3 | Dark | Movement Right to Left |

To achieve such a sequence for containers 200 in the system, the elevator devices 400 move between levels and extend the respective rams 425 in a selected sequence. An example of such a sequence is shown in Table 3. By implementing the sequence in Table 3, containers 200 move across the levels 310 as containers 200 are added to the levels 310. When a container 200 reaches the end of a level 312, the container is moved to another level 312 or is moved to the second conveying device 325 if the container 200 is ready for harvesting.

TABLE 3

| | | | | | time | |
|---|---|---|---|---|---|---|
| Seq | Up Elevator | | Down Elevator | | (min) | |
| No | Position | Ram | Position | Ram | 0 | operation |
| 1 | Level 0 (top) | in | Level 0 (top) | in | 0 | |
| 2 | Level 0 (top) | out | Level 0 (top) | in | 3 | Ram extend |
| | Level 1 | in | Level 1 | in | 3 | Move down |
| 3 | Level 1 | in | Level 1 | out | 3 | Ram extend |
| 4 | Level 0 (top) | in | Level 0 (top) | in | 3 | Move up |
| 5 | Level 0 (top) | out | Level 0 (top) | in | 6 | Ram extend |
| | | | | | | Move down |
| 6 | Level 5 | in | Level 5 | out | 6 | Ram extend |
| | Level 0 (top) | in | Level 0 (top) | in | 6 | Move up |
| 6 | Level 0 (top) | out | Level 0 (top) | in | 9 | Ram extend |
| | | | | | | Move down |
| 7 | Level 2 | in | Level 2 | out | 9 | Ram extend |
| | Level 0 (top) | in | Level 0 (top) | in | 9 | Move up |
| 8 | Level 0 (top) | out | Level 0 (top) | in | 12 | Ram extend |
| | | | | | | Move down |
| 9 | Level 6 | in | Level 6 | out | 12 | Ram extend |
| | Level 0 (top) | in | Level 0 (top) | in | 12 | Move up |
| 10 | Level 0 (top) | out | Level 0 (top) | in | 15 | Ram extend |
| | | | | | | Move down |
| 11 | Level 3 | in | Level 3 | out | 15 | Ram extend |
| | Level 0 (top) | in | Level 0 (top) | in | 15 | Move up |
| 12 | Level 0 (top) | out | Level 0 (top) | in | 18 | Ram extend |
| | | | | | | Move down |
| 13 | Level 7 | in | Level 7 | out | 18 | Ram extend |
| | Level 0 (top) | in | Level 0 (top) | in | 18 | Move up |
| 14 | Level 0 (top) | out | Level 0 (top) | in | 21 | Ram extend |
| | | | | | | Move down |
| 15 | Level 4 | in | Level 4 | out | 21 | Ram extend |
| | Level 0 (top) | in | Level 0 (top) | in | 21 | Move up |
| 16 | Level 0 (top) | out | Level 0 (top) | in | 24 | Ram extend |
| | | | | | | Move down |
| 17 | Level 8 | in | Level 8 | out | 24 | Ram extend |

When a container 200 is removed from the rack 300 for harvesting, another container 200 is added to the rack 300. Table 4 illustrates an example sequence for loading containers 200 onto the racks 300, for example, from the second conveying device 235. The example sequence comprises cycles in which a container 200 is loaded onto the highest level 312 and a container 200 is received from an opposing side of the highest level and moved to another level 310. Each cycle can be repeated, for example 20 times, before the sequence moves on to the next cycle.

TABLE 4

| | |
|---|---|
| Up Elevator | Down Elevator |

| Seq No | Position | Ram | Position | Ram |
|---|---|---|---|---|
| cycle 1 | Conveyor | in | Level 0 | out |
| cycle 1 | Level 0 | out | Level 1 | out |
| cycle 2 | Conveyor | in | Level 0 | out |
| cycle 2 | Level 1 | out | Level 1 | out |
| cycle 3 | Conveyor | in | Level 0 | out |
| cycle 3 | Level 2 | out | Level 1 | out |
| cycle 4 | Conveyor | in | Level 0 | out |
| cycle 4 | Level 3 | out | Level 1 | out |
| cycle 5 | Conveyor | in | Level 0 | out |
| cycle 5 | Level 4 | out | Level 1 | out |
| cycle 6 | Conveyor | in | Level 0 | out |
| cycle 6 | Level 5 | out | Level 1 | out |
| cycle 7 | Conveyor | in | Level 0 | out |
| cycle 7 | Level 6 | out | Level 1 | out |
| cycle 8 | Conveyor | in | Level 0 | out |
| cycle 8 | Level 7 | out | rack 1 | out |
| cycle 9 | Conveyor | in | Level 0 | out |
| cycle 9 | Level 8 | out | Level 1 | out |

If a crop 205 needs to be removed from the rack 300, for example, if the crop 205 is diseased, an emergency unload sequence can be implemented. In one example emergency unload sequence containers 200 are moved between two levels 310 of the rack 300 until the desired container 200 reaches the side of the level 310 and can be unloaded via the elevator device 400.

Embodiments of the present invention thus provide high density horticulture growing systems, methods and apparatus that address or at least ameliorate one or more of the aforementioned problems of the prior art. For example, embodiments of the present invention provide a high density horticulture growing system in which each crop 205 can receive an equal amount of natural light. Embodiments of the present invention also provide more full natural light to each crop than known high density horticulture growing systems. The high density horticulture growing system of the present invention consumes less energy and is more cost effective than prior art systems. For example, artificial lighting, which is expensive and consumes a significant amount of power, is not required to be used on every level 310 of the rack 300. LEDs also provide a much more efficient method of artificial lighting. Furthermore, in embodiments of the present invention containers 200 are moved which consumes far less power than moving whole plant racks which support plant trays in the prior art.

The high density horticulture growing systems of the present invention are designed to be transportable in a standard shipping container and be modular such that they can be scaled or expanded to different sizes and to suit different applications. For example, the components of the system 10 are designed to be shorter than the length of a standard shipping container and to be lightweight so that they are easily transported and assembled. For example, the system of the present invention including the building 100 can be assembled in 3-4 weeks or less. The system is flexible and adaptable in that the distance between vertically spaced levels 310 of the rack 300 can also be adjusted to suit different crops and different stages of growth.

Aspects of the system of the present invention are automatically controlled to reduce labour. Automated control of the growing environment is also provided. Remote reporting and monitoring is provided, for example, by sensors 810 which collect data on the environmental conditions and the growth process. This enables a quick response when there is a problem in the system, such as if a crop has a disease, and enables the time of harvesting to be accurately monitored and selected. Embodiments of the present invention also control the environmental conditions in which the crops are grown. For example, it is anticipated that embodiments of the present invention can operate when temperatures outside the building are as low as about −25 degrees Celsius or as high as about 45 degrees Celsius.

In embodiments of the present invention, water is provided directly to containers 200 in which the crops 205 are grown, and is recycled for reuse. This reduces the amount of water wasted when compared to inventions in the prior art where, for example, water is sprayed on the crops. The gravity driven conveying devices and the low power/low torque motors enable the crops to be moved while only producing a low level of noise and using a low level of energy. For example, in some embodiments, each elevator device 400 only moves for 20 seconds in each 3 minute period.

Embodiments of the present invention provide a greater crop yield per square metre than many prior art systems. For example, it is anticipated that embodiments of the present invention can produce 4.5 times the yield per square metre of a traditional hydroponic glass house.

In this specification, the terms “comprises”, “comprising” or similar terms are intended to mean a non-exclusive inclusion, such that an apparatus that comprises a list of elements does not include those elements solely, but may well include other elements not listed.

The reference to any prior art in this specification is not, and should not be taken as, an acknowledgement or any form of suggestion that the prior art forms part of the common general knowledge.

Throughout the specification the aim has been to describe the invention without limiting the invention to any one embodiment or specific collection of features. Persons skilled in the relevant art may realize variations from the specific embodiments that will nonetheless fall within the scope of the invention.

1. A high density horticulture growing system comprising:
one or more racks, each rack comprising a frame to which one or more longitudinal supports are coupled at a plurality of vertically spaced levels to support a plurality of containers in which crops are grown; and
one or more elevator devices to automatically move the containers between the vertically spaced levels.

2. (canceled)

3. (canceled)

4. (canceled)

5. The growing system of claim 3, wherein each longitudinal support comprises one or more of the following: a low friction surface; one or more brackets at each end of the support to couple the support to the frame at a selected height and/or a selected angle of inclination.

6. The growing system of claim 1, wherein each rack is modular such that the number and/or spacing of the vertically spaced levels can be changed.

7. The growing system of claim 1, wherein each of the elevator devices comprises a carrier to transport the containers between the vertically spaced levels.

8. The growing system of claim 7, wherein the carrier of each of the elevator devices comprises a platform to support one or more containers, wherein the platform is optionally inclined.

9. The growing system of claim 7, wherein each of the elevator devices comprises: a ram, such as a hydraulic ram, a pneumatic ram or an electric ram, to push the containers from the carrier onto the one or more longitudinal supports at the vertically spaced levels; and/or a drive system to move the respective carrier along the respective vertical guide between the vertically spaced levels.

10. The growing system of claim 711, 8 or 911, wherein the carrier of each of the elevator devices is mounted via one or more rollers to one or more vertical guides.

11. (canceled)

12. The growing system of claim 9, wherein the drive system comprises a chain drive or a belt drive coupled to the carrier and a motor which drives the chain drive or the belt drive to move the carrier.

13. The growing system of claim 12, wherein each of the elevator devices comprises a safety line to support the carrier if the chain drive or the belt drive fails.

14. The growing system of claim 1, comprising a first elevator device adjacent a first side of each rack and a second elevator device adjacent a second and opposing side of each rack.

15. The growing system of claim 1, further comprising a watering system to water the crops in each rack, wherein the watering system comprises a primary watering system to provide water to containers on a highest level of each rack and optionally to one or more lower levels of each rack.

16. (canceled)

17. The growing system of claim 15, wherein the watering system comprises a secondary watering system to circulate water through at least part of the longitudinal supports of each rack.

18. The growing system of claim 15, wherein the watering system comprises one or more water outlets on each rack which align with a respective input aperture of each container to provide water to the container when the container is in a predetermined position on the rack.

19. The growing system of claim 1, wherein each container is elongate and comprises one or more of the following: a plurality of crop apertures to receive crops; one or more channels to direct water to the crops; an output aperture to enable unused water to exit the container.

20. (canceled)

21. (canceled)

22. The growing system claim 15, wherein a temperature of the water in the primary watering system and/or the secondary watering system is controlled to control a temperature of the containers, the longitudinal supports and/or the air surrounding the rack.

23. The growing system of claim 1, wherein the rack comprises one or more of the following: artificial lighting, such as one or more light emitting diodes (LEDs), at one or more levels of the rack, such as at every second level of the rack; one or more air blowers, such as one or more fans, at one or more levels of the rack; one or more readers to read a unique identifier on each of the containers as the container passes a location on the rack.

24. (canceled)

25. (canceled)

26. The growing system of claim 1, further comprising a first conveying device to move containers horizontally to each rack from a crop planting area.

27. The growing system of claim 26, wherein the first conveying device includes an inclined section which slopes downward from the crop planting area toward a lower region of the respective rack.

28. The growing system of claim 26, wherein the carrier of one of the elevator devices lifts containers, transported to the rack by the first conveying device, to a highest level of the respective rack.

29. The growing system of claim 26, further comprising a second conveying device to move containers from each rack to a crop storage area.

30. The growing system of claim 29, wherein the second conveying device includes one or more driven rollers to move the containers from the rack to the crop storage area.

31. The growing system of claim 29, wherein the carrier of one of the elevator devices lowers containers onto the second conveying device from one or more levels of the respective rack.

32. The growing system claim 29, wherein the second conveying device receives containers from the first conveying device, and the carrier of one of the elevator devices lifts the containers from the second conveying device onto the respective rack.

33. The growing system of claim 26, wherein, when a container is moved from one of the racks to a crop storage area, the respective rack receives a container from the crop planting area.

34. The growing system of claim 26, wherein the crop storage area comprises one or more of the following: an inclined conveyor to move containers from one side of the storage area to the other; a bench for housing the inclined conveyor; one or more elevators to lift the containers from the inclined conveyor to a surface of the bench; one or more sealable doors in one or more walls or surfaces of the bench.

35. The growing system of claim 2, further comprising a processor to control one or more of the following aspects of the high density horticulture growing system: loading and unloading of the containers; movement of the containers between levels of the rack; movement of the containers between planting, growing, harvesting and storage areas; planting times; growing durations; harvesting times; watering; cleaning; power consumption; growing conditions, including fertilisers, nutrients, carbon dioxide (CO₂) levels, light spectrum, lighting levels, temperature, humidity, ventilation, air pressure.

36. The growing system of claim 1, further comprising one or more of the following sensors to monitor one or more parameters relating to the growing system: temperature sensors, humidity sensors, pressure sensors, light sensors, location sensors, cameras, product traceability sensors, irrigation sensors, water quality sensors, electrical conductivity sensors, pH sensors, carbon dioxide sensors, plant growth sensors.

37. (canceled)

38. A building housing the high density horticulture growing system of claim 1, wherein a positive pressure is maintained within the building.

39. (canceled)

40. The building of claim 38, wherein building comprises one or more of the following: a transparent roof, or part thereof, and/or one or more transparent walls, or part thereof, to enable natural light to enter the building; a roof and/or one or more walls, or parts thereof, made from glass or a dual layer plastic; one or more openable and closable vents in a roof and/or wall; one or more fans to circulate air; one or more movable shade screens; an internal wall dividing a crop growing area from a crop planting area and a crop harvesting area.

41. (canceled)

42. (canceled)

43. A crop growing method in a high density horticultural growing system comprising one or more racks, each rack comprising a frame to which one or more longitudinal supports are coupled at a plurality of vertically spaced levels to support a plurality of containers in which crops are grown and one or more elevator devices to automatically move the containers between the vertically spaced levels, the method comprising:
growing crops in the plurality of containers; and
automatically moving the plurality of containers between the vertically spaced levels via the one or more elevator devices while the crops grow to control growth conditions for the crops in the containers.

44. (canceled)

45. The method of claim 43, comprising moving each of the containers through a highest of the vertically spaced levels to expose the crops in the respective container to maximum natural light levels.

46. The method of claim 43, comprising moving two or more of the containers such that the two or more containers receive a similar amount of natural light during a predetermined period, such as two or more containers comprising a certain crop.

47. The method of claim 43, comprising moving each of the containers to the highest of the vertically spaced levels for the same duration, or a similar duration each day during daylight.

48. The method of claim 43, comprising watering the crops in the containers when the containers are at the highest of the vertically spaced levels.

49. The method of claim 43, comprising: receiving a first container from a first level of the rack on a carrier of a first elevator device; pushing the first container from the carrier onto a second level of the rack; pushing one or more second containers on the second level of the rack across the second level by the first container; and pushing at least one of the second containers from an opposing side of the second level onto a carrier of a second elevator device by the first container.

50. (canceled)

51. (canceled)

52. (canceled)

53. The method of claim 43 comprising: one or more of the following: moving containers at least horizontally to each rack from a crop planting area via a first conveying device; moving containers at least horizontally from each rack to a crop storage area via a second conveying device.

54. (canceled)

55. A non-transitory computer readable medium comprising computer readable code components that when selectively executed by a computer processor automatically move containers of a high density horticulture growing system comprising one or more racks, each rack comprising a frame to which one or more longitudinal supports are coupled at a plurality of vertically spaced levels to support a plurality of containers in which crops are grown; and one or more elevator devices to automatically move the containers between the vertically spaced levels while crops grow in the containers.

56. The computer readable medium of claim 55, wherein the selective execution of the computer readable code components by the processor causes performance of the method as claimed in claim 49.

57. A kit for the construction of the high density horticulture growing system of claim 1, wherein the kit is transportable in a shipping container.

58. A high density horticulture growing system comprising a crop planting area, a crop growing area and a crop storage area, the system further comprising:
one or more racks each comprising a plurality of the vertically spaced levels;
a first conveying device to move containers, in which crops are grown, at least horizontally to each rack from the crop planting area;
one or more elevator devices to automatically move the containers between the vertically spaced levels of the racks; and
a second conveying device to move containers at least horizontally from each rack to the crop storage area.

59. (canceled)

60. The system of claim 58, further comprising one or more of the following: a crop harvesting and packing area adjacent the crop storage area; a computing device in communication with the first and second conveying devices and the one or more elevator devices, the computing device comprising a computer processor in communication with a non-transitory computer readable medium comprising computer readable code components that when selectively executed by the processor cause movement of the containers at least horizontally between the crop planting area, the crop growing area and the crop storage area and movement of the containers between the vertically spaced levels of the racks.

61. A plurality of high density horticulture growing systems as claimed in claim 1 in communication with a centralised data monitoring and collection system via one or more communication networks, wherein the centralised data monitoring and collection system transmits and receives data relating to the growing of crops to and from the plurality of high density horticulture growing systems.
